(19) United States
(12) Patent Application Publication
(10) Pub. No.: US 2024/0147223 A1
(43) Pub. Date: May 2, 2024

(54) REMOTE CONFIGURATION METHOD OF USER EQUIPMENT, AND METHOD FOR DETERMINING REMOTE CONFIGURATION MODE

(71) Applicant: BEIJING XIAOMI MOBILE SOFTWARE CO., LTD., Beijing (CN)

(72) Inventors: Xiaowei JIANG, Beijing (CN); Wei HONG, Beijing (CN)

(73) Assignee: BEIJING XIAOMI MOBILE SOFTWARE CO., LTD., Beijing (CN)

(21) Appl. No.: 18/279,675

(22) PCT Filed: Mar. 1, 2021
(86) PCT No.: PCT/CN2021/078552

§ 371 Date: Aug. 31, 2023

(51) Int. Cl. H04W 8/24; H04W 60/00

(52) U.S. Cl. CPC H04W 8/245; H04W 60/00

(57) ABSTRACT

The present disclosure provides a remote configuration method of a UE, an apparatus, and a communication device. The method includes: sending a registration request to a first core network device of a first network by means of a UE; the UE receiving an available remote configuration mode sent by the first core network device, wherein the available remote configuration mode is determined by a remote configuration mode supported by the first network and/or by a remote configuration mode supported by a second network; and the UE performing remote configuration according to the available remote configuration mode.

### CROSS-REFERENCE

The present disclosure is a U.S. National Stage of International Application No. PCT/CN2021/078552, filed on Mar. 1, 2021, the contents of which are incorporated herein by reference in their entireties for all purposes.

### BACKGROUND

Vertical industries have become important deployment scenarios for 5th generation mobile networks (5G) commercial uses, such as concert venues (which can be regarded as a Standalone Non-Public Network (SNPN)), where more professional and higher-quality music/video services can be provided by means of the SNPN. And a Public Land Mobile Network (PLMN) can provide ordinary services such as data, and voice by utilizing wide coverage. In this way, users can reasonably select a network according to needs to obtain corresponding services.

Subscription data of PLMN users is stored in Subscriber Identity Modules (SIMs). When a user buys a new mobile phone, the user needs to go to an operator to buy a SIM card and insert it into the mobile phone to perform network selection and registration, and other processes through data in the SIM card. There is typically no SIM card in the SNPN, and the subscription data needs to be sent to devices through remote configuration.

At present, one of main research issues of the 3GPP eNPN project is how to remotely configure a User Equipment (UE) in the SNPN, that is, how to send the subscription data to the UE. The remote configuration of the subscription data through user plane and control plane schemes is supported in standards.

### SUMMARY

The present disclosure relates to the field of wireless communication technologies, and more particularly, to a remote configuration method for a user equipment and a method for determining a remote configuration mode.

According to a first aspect of the present disclosure, some embodiments provide a method for remotely configuring a User Equipment (UE), including: sending, by the UE, a registration request to a first core network device of a first network; receiving, by the UE, an available remote configuration mode sent by the first core network device, wherein the available remote configuration mode is determined by a remote configuration mode supported by the first network and/or a remote configuration mode supported by a second network; and performing, by the UE, remote configuration according to the available remote configuration mode.

According to a second aspect of the present disclosure, some embodiments provide a method for determining a remote configuration mode, including: receiving, by a first core network device of a first network, a registration request of a User Equipment (UE); determining, by the first core network device, an available remote configuration mode according to a remote configuration mode supported by the first network and/or a remote configuration mode supported by a second network; and sending, by the first core network device, the available remote configuration mode to the UE.

According to a third aspect of the present disclosure, some embodiments provide another method for determining a remote configuration mode, including: receiving, by a second core network device of a second network, a UE registration success message sent by a first core network device of a first network; and sending, by the second core network device, a remote configuration mode supported by the second network to the first core network device, so that an available remote configuration mode is generated by the first core network device according to a remote configuration mode supported by the first network and/or the remote configuration mode supported by the second network.

According to a fourth aspect of the present disclosure, some embodiments provide a method for remotely configuring a User Equipment (UE), including: sending, by the UE, a configuration request to a second core network device of a second network, wherein the configuration request includes a remote configuration mode supported by a first network and/or the UE; and receiving, by the UE, remote configuration information.

According to a fifth aspect of the present disclosure, some embodiments provide another method for determining a remote configuration mode, including: receiving, by a second core network device of a second network, a configuration request sent by a User Equipment (UE), wherein the configuration request includes a remote configuration mode supported by a first network and/or the UE; and sending, by the second core network device, remote configuration information to the UE.

According to a sixth aspect of the present disclosure, some embodiments provide an apparatus for remotely configuring a User Equipment (UE), including: a sending module, configured to send a registration request to a first core network device of a first network; a receiving module, configured to receive an available remote configuration mode sent by the first core network device, wherein the available remote configuration mode is determined by a remote configuration mode supported by the first network and/or a remote configuration mode supported by the second network; and a configuration module, configured to perform remote configuration according to the available remote configuration mode.

According to a seventh aspect of the present disclosure, some embodiments provide an apparatus for determining a remote configuration mode, including: a receiving module, configured to receive a registration request of a UE; a determining module, configured to determine an available remote configuration mode according to a remote configuration mode supported by the first network and/or a remote configuration mode supported by a second network; and a sending module, configured to send the available remote configuration mode to the UE.

According to a eighth aspect of the present disclosure, some embodiments provide another apparatus for determining a remote configuration mode, including: a receiving module, configured to receive a UE registration success message sent by a first core network device of a first network; and a sending module, configured to send a remote configuration mode supported by the second network to the first core network device, so that an available remote configuration mode is generated by the first core network device according to a remote configuration mode supported by the first network and the remote configuration mode supported by the second network.

According to a ninth aspect of the present disclosure, some embodiments provide an apparatus for remotely configuring a User Equipment (UE), including: a first sending module, configured to send a configuration request to a second core network device of a second network, wherein the configuration request includes a remote configuration mode supported by a first network and/or the UE; and a receiving module, configured to receive remote configuration information.

According to a tenth aspect of the present disclosure, some embodiments provide another apparatus for determining a remote configuration mode, including: a receiving module, configured to receive a configuration request sent by a User Equipment (UE), wherein the configuration request includes a remote configuration mode supported by a first network and/or the UE; and a sending module, configured to send remote configuration information to the UE.

According to a eleventh aspect of the present disclosure, some embodiments provide a communication device, including: a transceiver; a memory; and a processor, respectively connected to the transceiver and the memory, and configured to, by executing computer-executable instructions in the memory, control a wireless signal transmission and reception of the transceiver, and implement the method for remotely configuring the UE provided in the first aspect of the present disclosure, or implement the method for determining the remote configuration mode provided in the second aspect of the present disclosure, or implement the method for determining the remote configuration mode provided in the third aspect of the present disclosure, or implement the method for remotely configuring the UE provided in the fourth aspect of the present disclosure, or implement the method for determining the remote configuration mode provided in the fifth aspect of the present disclosure.

According to a twelve aspect of the present disclosure, some embodiments provide a computer storage medium having computer-executable instructions stored thereon, which, when executed by a processor, are capable of implementing the method for remotely configuring the UE provided in the first aspect of the present disclosure, or implementing the method for determining the remote configuration mode provided in the second aspect of the present disclosure, or implementing the method for determining the remote configuration mode provided in the third aspect of the present disclosure, or implementing the method for remotely configuring the UE provided in the fourth aspect of the present disclosure, or implementing the method for determining the remote configuration mode provided in the fifth aspect of the present disclosure.

According to a thirteenth aspect of the present disclosure, some embodiments provide a computer program product, including a computer program, which, when executed by a processor, implements the method for remotely configuring the UE provided in the first aspect of the present disclosure, or implements the method for determining the remote configuration mode provided in the second aspect of the present disclosure, or implements the method for determining the remote configuration mode provided in the third aspect of the present disclosure, or implements the method for remotely configuring the UE provided in the fourth aspect of the present disclosure, or implements the method for determining the remote configuration mode provided in the fifth aspect of the present disclosure.

Additional aspects and advantages of the present disclosure will be provided in part in the following description, and in part will be apparent from the following description, or learned by practice of the present disclosure.

### BRIEF DESCRIPTION OF THE DRAWINGS

The above and/or additional aspects and advantages of the present disclosure will become apparent and easy to understand from the following description of embodiments in conjunction with the accompanying drawings, in which:

FIG. 1 is a schematic flowchart of a method for remotely configuring a User Equipment (UE) provided by an embodiment of the present disclosure;

FIG. 2 is a schematic flowchart of another method for remotely configuring a User Equipment (UE) provided by an embodiment of the present disclosure;

FIG. 3 is a schematic flowchart of another method for remotely configuring a User Equipment (UE) provided by an embodiment of the present disclosure;

FIG. 4 is a schematic flowchart of another method for remotely configuring a User Equipment (UE) provided by an embodiment of the present disclosure;

FIG. 5 is a schematic flowchart of a method for determining a remote configuration mode provided by an embodiment of the present disclosure;

FIG. 6 is a schematic flowchart of another method for determining a remote configuration mode provided by an embodiment of the present disclosure;

FIG. 7 is a schematic flowchart of another method for determining a remote configuration mode provided by an embodiment of the present disclosure;

FIG. 8 is a schematic flowchart of another method for determining a remote configuration mode provided by an embodiment of the present disclosure;

FIG. 9 is a schematic flowchart of another method for determining a remote configuration mode provided by an embodiment of the present disclosure;

FIG. 10 is a schematic flowchart of another method for determining a remote configuration mode provided by an embodiment of the present disclosure;

FIG. 11 is a schematic flowchart of another method for determining a remote configuration mode provided by an embodiment of the present disclosure;

FIG. 12 is a schematic flowchart of another method for remotely configuring a UE provided by an embodiment of the present disclosure;

FIG. 13 is a schematic flowchart of another method for remotely configuring a UE provided by an embodiment of the present disclosure;

FIG. 14 is a schematic flowchart of another method for remotely configuring a UE provided by an embodiment of the present disclosure;

FIG. 15 is a schematic flowchart of another method for remotely configuring a UE provided by an embodiment of the present disclosure;

FIG. 16 is a schematic flowchart of another method for determining a remote configuration mode provided by an embodiment of the present disclosure;

FIG. 17 is a schematic flowchart of another method for determining a remote configuration mode provided by an embodiment of the present disclosure;

FIG. 18 is a schematic structural diagram of an apparatus for remotely configuring a User Equipment (UE) provided by an embodiment of the present disclosure;

FIG. 19 is a schematic structural diagram of an apparatus for determining a remote configuration mode provided by an embodiment of the present disclosure;

FIG. 20 is a schematic structural diagram of another apparatus for determining a remote configuration mode provided by an embodiment of the present disclosure;

FIG. 21 is a schematic structural diagram of another apparatus for remotely configuring a User Equipment (UE) provided by an embodiment of the present disclosure;

FIG. 22 is a schematic structural diagram of another apparatus for determining a remote configuration mode provided by an embodiment of the present disclosure;

FIG. 23 is a schematic structural diagram of another apparatus for determining a remote configuration mode provided by an embodiment of the present disclosure;

FIG. 24 is a block diagram of a user equipment provided by an embodiment of the present disclosure; and

FIG. 25 is a schematic structural diagram of a network device provided by an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of embodiments of the present disclosure as recited in the appended claims.

The terms used in embodiments of the present disclosure are merely for the purpose of describing particular embodiments and are not intended to limit embodiments of the present disclosure. As used in embodiments of the present disclosure and the appended claims, the singular forms “a” and “said” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, first information may also be referred to as second information, and similarly, the second information may also be referred to as the first information. Depending on the context, the word “if” as used herein can be interpreted as “upon” or “when” or “in response to determination”.

Embodiments of the present disclosure are described in detail below, examples of which are illustrated in the accompanying drawings, where like or similar reference signs designate like or similar elements throughout. Embodiments described below with reference to the accompanying drawings are illustrative, and are intended to explain the present disclosure and should not be construed as limiting the present disclosure.

In the prior art, a remote configuration process for a SNPN UE is as follows.

1. The UE pre-configures a network access parameter, for example, authentication is performed when the UE accesses a network.

2. The UE accesses a new customer network through the pre-configured parameter (the UE obtains subscription data from a home network through this new customer network).

3. The UE obtains subscription configuration data from the home network through a control plane or user plane scheme.

However, the existing remote configuration method for the UE in the SNPN only takes a capability of an Onboarding Standalone Non-Public Network (O-SNPN) into account, without referring a capability of a Subscription Owner Standalone Non-Public Network (SO-SNPN). A case that the O-SNPN supports the remote configuration for the SNPN UE, but the SO-SNPN does not support the remote configuration for the SNPN UE may occur. In addition, the use of the independent capability negotiation, that is, UE reporting and network feedback, needs the increased signaling overhead.

In view of the above problems, the present disclosure provides a method and apparatus for remotely configuring a User Equipment (UE), and a communication device.

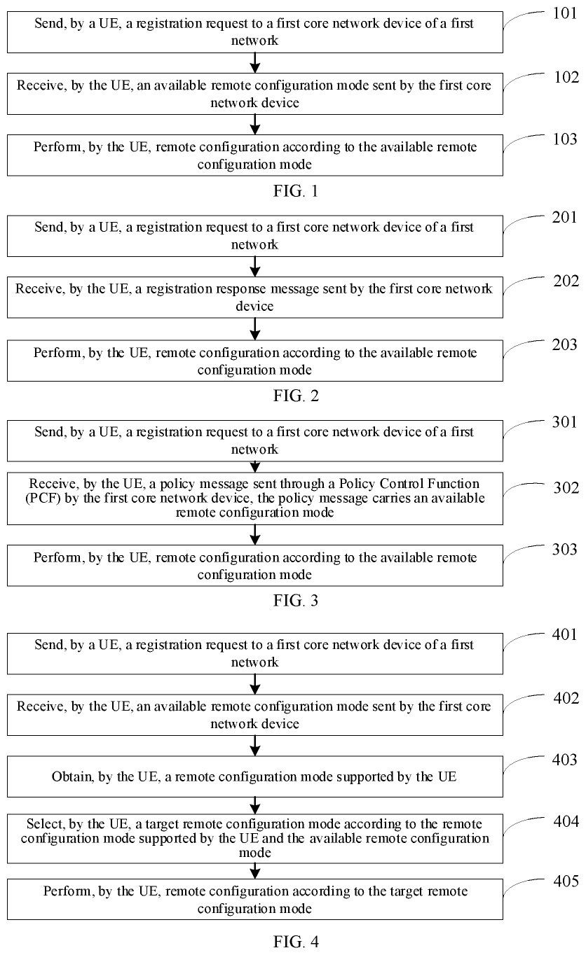

FIG. 1 is a schematic flowchart of a method for remotely configuring a User Equipment (UE) provided by an embodiment of the present disclosure. The method for remotely configuring the UE may be applied to the UE.

The UE may be called a terminal device. The terminal device may be a device that provides voice and/or data connectivity to a user, a handheld device with wireless connectivity functions, or other processing devices connected to a wireless modem, etc. The name of the terminal device may also vary in different systems, for example, the terminal device may be called a UE in a 5G system, where a wireless terminal device may communicate with one or more Core Networks (CNs) via a Radio Access Network (RAN), and the wireless terminal device may be a mobile terminal device, such as a mobile phone (or “cellular” phone) and a computer with a mobile terminal device, for example, it may be portable, pocket-sized, handheld, computer-built, or vehicle-mounted mobile devices that exchange voice and/or data with the radio access network.

For example, the terminal device may be a Personal Communication Service (PCS) phone, a cordless phone, a Session Initiated Protocol (SIP) phone, a Wireless Local Loop (WLL) station, a Personal Digital Assistant (PDA) and other devices. The wireless terminal device may also be called a system, a subscriber unit, a subscriber station, a mobile station, a mobile, a remote station, an access point, a remote terminal, an access terminal, a user terminal, a user agent, and a user device, which is not limited in embodiments of the present disclosure.

As shown in FIG. 1, the method for remotely configuring the UE may include the following steps 101 to 103.

In the step 101, the UE sends a registration request to a first core network device of a first network.

As an implementation of embodiments of the present disclosure, the first network may be an O-SNPN.

The registration request refers to the one sent by the UE to request a new user registration.

In embodiments of the present disclosure, the UE may send the registration request to the first core network device of the first network, so as to initiate a remote configuration process for the UE.

The first core network device may be an Access and Mobility Management Function (AMF) or a Policy Control Function (PCF). The AMF is a main functional unit of 5GC, which completes the access and mobility management of terminal user.

In the step 102, the UE receives an available remote configuration mode sent by the first core network device.

The available remote configuration mode is determined by a remote configuration mode supported by the first network and/or a remote configuration mode supported by a second network. For example, the available remote configuration mode may be a remote configuration mode available on a network side, or a remote configuration mode that can be supported by the network side.

As an implementation of embodiments of the present disclosure, the UE may receive the available remote configuration mode determined by the remote configuration mode supported by the first network that is sent by the first core network device.

For example, assuming that the available remote configuration mode determined by the remote configuration mode supported by the first network is a User Plane (UP) remote configuration mode, the available remote configuration mode sent by the first core network device that can be received by the UE is the UP remote configuration mode.

As another implementation of embodiments of the present disclosure, the UE may receive the available remote configuration mode determined by the remote configuration mode supported by the second network that is sent by the first core network device.

For example, assuming that the available remote configuration mode determined by the remote configuration mode supported by the second network is the UP remote configuration mode and a Control Plane (CP) remote configuration mode, the available remote configuration mode sent by the first core network device that can be received by the UE is the UP remote configuration mode and the CP remote configuration mode.

As yet another implementation of embodiments of the present disclosure, the UE may receive the available remote configuration mode determined by the remote configuration mode supported by the first network and the remote configuration mode supported by the second network that is sent by the first core network device.

In some embodiments of the present disclosure, the available remote configuration mode sent by the first core network device that can be received by the UE is a remote configuration mode commonly supported by the first network and the second network.

For example, assuming that the available remote configuration mode determined by the remote configuration mode supported by the first network is the UP remote configuration mode and the CP remote configuration mode, and the available remote configuration mode determined by the remote configuration mode supported by the second network is the UP remote configuration mode, the available remote configuration mode sent by the first core network device that can be received by the UE is the UP remote configuration mode.

The remote configuration mode supported by the first network and the remote configuration mode supported by the second network in the above examples are only illustrative description, which are not limited in embodiments of the present disclosure.

In the step 103, the UE performs remote configuration according to the available remote configuration mode.

In embodiments of the present disclosure, upon receiving the available remote configuration mode sent by the first core network device, the UE may perform the remote configuration according to the received available remote configuration mode.

As an implementation of embodiments of the present disclosure, the available remote configuration mode sent by the first core network device that is received by the UE is the UP remote configuration mode, and the UE performs the remote configuration according to the received UP remote configuration mode.

As another implementation of embodiments of the present disclosure, the available remote configuration mode sent by the first core network device that is received by the UE is the CP remote configuration mode, and the UE performs the remote configuration according to the received CP remote configuration mode.

As yet another implementation of embodiments of the present disclosure, the available remote configuration mode sent by the first core network device that is received by the UE is the UP remote configuration mode and the CP remote configuration mode, the UE can perform the remote configuration according to the received UP remote configuration mode or CP remote configuration mode, depending on a mode supported by itself.

In the method for remotely configuring the UE provided by embodiments of the present disclosure, the UE sends the registration request to the first core network device of the first network; and upon receiving the available remote configuration mode sent by the first core network device, the UE performs the remote configuration according to the available remote configuration mode. Since the available remote configuration mode is determined according to the remote configuration modes supported by the first network and/or the second network, it is realized that the UE performs the remote configuration by selecting the remote configuration mode supported by itself from the available remote configuration mode, avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for remotely configuring a User Equipment (UE), and FIG. 2 is a schematic flowchart of another method for remotely configuring a User Equipment (UE) provided by an embodiment of the present disclosure. The method for remotely configuring the UE may be applied to the UE. The method for remotely configuring the UE may be executed individually, or may be executed in combination with any embodiment or any implementation in embodiments in the present disclosure, or may be executed in combination with any technical solution in the related arts.

As shown in FIG. 2, the method for remotely configuring the UE may include the following steps 201 to 203.

In the step 201, the UE sends a registration request to a first core network device of a first network.

The step 201 may be implemented by adopting any of various embodiments of the present disclosure, which is not limited in embodiments of the present disclosure, and will also not be repeated here.

In the step 202, the UE receives a registration response message sent by the first core network device.

If the registration response message is a registration success message, the registration response message carries an available remote configuration mode.

In embodiments of the present disclosure, after the UE sends the registration request to the first core network device of the first network, the first core network device sends the registration response message to the UE in response to the received registration request, so that the UE receives the registration response message sent by the first core network device.

As an implementation of embodiments of the present disclosure, after receiving the registration request sent by the UE, the first core network device authenticates the registration request. When determining that the registration fails, the first core network device sends to the UE the registration response message that the registration fails.

As another implementation of embodiments of the present disclosure, after receiving the registration request sent by the UE, the first core network device authenticates the received registration request. When determining that the registration is successful, the first core network device sends to the UE the registration success message carrying the available remote configuration mode.

The available remote configuration mode is determined by a remote configuration mode supported by the first network and/or a remote configuration mode supported by a second network, and may be a UP remote configuration mode and/or a CP remote configuration mode.

In an implementation, the first core network device authenticates the registration request sent by the UE. When determining that the registration is successful, the first core network device may send to the UE the registration success message carrying the UP remote configuration mode, so that the UE receives the registration response message carrying the UP remote configuration mode sent by the first core network device.

In another implementation, the first core network device authenticates the registration request sent by the UE. When determining that the registration is successful, the first core network device may send to the UE the registration success message carrying the CP remote configuration mode, so that the UE receives the registration response message carrying the CP remote configuration mode sent by the first core network device.

In yet another implementation, the first core network device authenticates the registration request sent by the UE. When determining that the registration is successful, the first core network device may send to the UE the registration success message carrying the UP remote configuration mode and the CP remote configuration mode, so that the UE receives the registration response message carrying the UP remote configuration mode and the CP remote configuration mode sent by the first core network device.

In the step 203, the UE performs remote configuration according to the available remote configuration mode.

The step 203 may be implemented by adopting any of various embodiments of the present disclosure, which is not limited in embodiments of the present disclosure, and will also not be repeated here.

In the method for remotely configuring the UE in embodiments of the present disclosure, the UE sends the registration request to the first core network device of the first network, and upon receiving the registration response message carrying the available remote configuration mode sent by the first core network device, the UE performs the remote configuration according to the available remote configuration mode. In this way, the UE can perform the remote configuration according to the available remote configuration mode carried in the received registration response message, avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for remotely configuring a User Equipment (UE), and FIG. 3 is a schematic flowchart of another method for remotely configuring a User Equipment (UE) provided by an embodiment of the present disclosure. The method for remotely configuring the UE may be applied to the UE. The method for remotely configuring the UE may be executed individually, or may be executed in combination with any embodiment or any implementation in embodiments in the present disclosure, or may be executed in combination with any technical solution in the related arts.

As shown in FIG. 3, the method for remotely configuring the UE may include the following steps 301 to 303.

In the step 301, the UE sends a registration request to a first core network device of a first network.

The step 301 may be implemented by adopting any of various embodiments of the present disclosure, which is not limited in embodiments of the present disclosure, and will also not be repeated here.

In the step 302, the UE receives a policy message sent through a Policy Control Function (PCF) by the first core network device, and the policy message carries an available remote configuration mode.

The available remote configuration mode is determined by a remote configuration mode supported by the first network and/or a remote configuration mode supported by a second network, and may be a UP remote configuration mode and/or a CP remote configuration mode.

In embodiments of the present disclosure, after the UE sends the registration request to the first core network device of the first network, the first core network device determines the available remote configuration mode according to the remote configuration modes supported by the first network and/or the second network, and then the first core network device may send to the UE, the policy message carrying the available remote configuration mode, through the PCF.

As an implementation of embodiments of the present disclosure, upon determining the available remote configuration mode according to the remote configuration mode supported by the first network, the first core network device may send to the UE, the policy message carrying the available remote configuration mode that is determined by the remote configuration mode supported by the first network, through the PCF.

For example, assuming that the remote configuration mode supported by the first network is the UP remote configuration mode, the UE may receive the policy message carrying the UP remote configuration mode sent through the PCF by the first core network device.

As another implementation of embodiments of the present disclosure, upon determining the available remote configuration mode according to the remote configuration mode supported by the second network, the first core network device may send to the UE, the policy message carrying the available remote configuration mode that is determined by the remote configuration mode supported by the second network, through the PCF.

For example, assuming that the remote configuration mode supported by the second network is the CP remote configuration mode, the UE may receive the policy message carrying the CP remote configuration mode sent through the PCF by the first core network device.

As yet another implementation of embodiments of the present disclosure, upon determining the available remote configuration mode according to the remote configuration mode supported by the first network and the remote configuration mode supported by the second network, the first core network device may send to the UE, the policy message carrying the available remote configuration mode that is determined by the remote configuration mode supported by the first network and the remote configuration mode supported by the second network, through the PCF.

For example, assuming that the remote configuration mode supported by the first network is the UP remote configuration mode, the remote configuration mode supported by the second network is the UP remote configuration mode and the CP remote configuration mode, the UE may receive the policy message carrying the UP remote configuration mode commonly supported by the first network and the second network sent through the PCF by the first core network device.

The remote configuration mode supported by the first network and the remote configuration mode supported by the second network in the above examples are only illustrative description, which are not limited in embodiments of the present disclosure.

It should be explained that the first core network device first sends to a base station the policy message carrying the available remote configuration mode, to send the policy message to the UE via the base station, so that the UE can receive the policy message sent through the PCF by the first core network device.

The base station may include a plurality of cells that provide services for the terminal device. Depending on specific application scenes, each cell can contain a plurality of Transmitting Receiving Points (TRPs) or devices in an access network that communicate with wireless terminal devices through one or more sectors on air interfaces, which may have other names. For example, the base station involved in embodiments of the present disclosure may be a Base Transceiver Station (BTS) in a Global System for Mobile communications (GSM) or a Code Division Multiple Access (CDMA), or a NodeB in a Wide-band Code Division Multiple Access (WCDMA), or an evolutional Node B (referred to as eNB or e-NodeB for short) in a Long Term Evolution (LTE) system, a 5G base station (referred to as gNB for short) in the next generation system, or a Home evolved Node B (HeNB), or a relay node, or a femto, or a pico, etc., which is not limited in embodiments of the present disclosure.

In the step 303, the UE performs remote configuration according to the available remote configuration mode.

The step 303 may be implemented by adopting any of various embodiments of the present disclosure, which is not limited in embodiments of the present disclosure, and will also not be repeated here.

In the method for remotely configuring the UE in embodiments of the present disclosure, the UE sends the registration request to the first core network device of the first network, receives the policy message carrying the available remote configuration mode sent through the PCF by the first core network device, and performs the remote configuration according to the available remote configuration mode. In this way, the UE can perform the remote configuration according to the available remote configuration mode carried in the received policy message in the actual remote configuration process, avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for remotely configuring a User Equipment (UE), and FIG. 4 is a schematic flowchart of another method for remotely configuring a User Equipment (UE) provided by an embodiment of the present disclosure. The method for remotely configuring the UE may be applied to the UE. The method for remotely configuring the UE may be executed individually, or may be executed in combination with any embodiment or any implementation in embodiments in the present disclosure, or may be executed in combination with any technical solution in the related arts.

As shown in FIG. 4, the method for remotely configuring the UE may include the following steps 401 to 405.

In the step 401, the UE sends a registration request to a first core network device of a first network.

In the step 402, the UE receives an available remote configuration mode sent by the first core network device.

The available remote configuration mode is determined by a remote configuration mode supported by the first network and/or a remote configuration mode supported by a second network.

The steps 401 to 402 may be implemented by adopting any of various embodiments of the present disclosure, respectively, which are not limited in embodiments of the present disclosure, and will also not be repeated here.

In the step 403, the UE obtains a remote configuration mode supported by the UE.

As an implementation of embodiments of the present disclosure, the UE may configure the remote configuration mode supported by itself in advance, so that the UE may obtain the supported remote configuration mode.

For example, the remote configuration mode supported by the UE may be the UP remote configuration mode, the CP remote configuration mode, or both the UP remote configuration mode and the CP remote configuration mode, which is not limited here.

As another implementation of embodiments of the present disclosure, the UE may further determine the supported remote configuration mode according to current network load information.

For example, it can be determined, through the current network load information, that the remote configuration mode currently supported by the UE may be the UP remote configuration mode, the CP remote configuration mode, or both the UP remote configuration mode and the CP remote configuration mode, which is not limited here.

As another implementation of embodiments of the present disclosure, the UE may further determine the remote configuration mode supported by itself according to a local policy configuration.

For example, it can be determined, through the local policy configuration of the UE, that the remote configuration mode currently supported by the UE may be the UP remote configuration mode, the CP remote configuration mode, or both the UP remote configuration mode and the CP remote configuration mode, which is not limited here.

In the step 404, the UE selects a target remote configuration mode according to the remote configuration mode supported by the UE and the available remote configuration mode.

The target remote configuration mode refers to a remote configuration mode adopted when the remote configuration is actually performed on the UE.

In embodiments of the present disclosure, after the UE receives the available remote configuration mode sent by the first core network device, and obtains the remote configuration mode supported by itself, the UE can select the target remote configuration mode according to the remote configuration mode supported by itself and the available remote configuration mode.

As an implementation of embodiments of the present disclosure, the available remote configuration mode sent by the first core network device that is received by the UE is the UP remote configuration mode, and the remote configuration mode supported by the UE itself is also the UP remote configuration mode, then it may be determined that the target remote configuration mode is the UP remote configuration mode.

As another implementation of embodiments of the present disclosure, the available remote configuration mode sent by the first core network device that is received by the UE is the CP remote configuration mode, and the remote configuration mode supported by the UE itself is the CP remote configuration mode, then it may be determined that the target remote configuration mode is the CP remote configuration mode.

As yet another implementation of embodiments of the present disclosure, the available remote configuration mode sent by the first core network device that is received by the UE is the UP remote configuration mode and the CP remote configuration mode, and the remote configuration mode supported by the UE itself is the CP remote configuration mode, then it may be determined that the target remote configuration mode is the CP remote configuration mode.

As still another implementation of embodiments of the present disclosure, the available remote configuration mode sent by the first core network device that is received by the UE is the UP remote configuration mode and the CP remote configuration mode, and the remote configuration mode supported by the UE itself is the UP remote configuration mode, then it may be determined that the target remote configuration mode is the UP remote configuration mode.

As still another implementation of embodiments of the present disclosure, the available remote configuration mode sent by the first core network device that is received by the UE is the UP remote configuration mode and the CP remote configuration mode, and the remote configuration mode supported by the UE itself is also the UP remote configuration mode and the CP remote configuration mode, then the UE may determine that the target remote configuration mode is the UP remote configuration mode or the CP remote configuration mode, depending on a specific implementation.

In the step 405, the UE performs remote configuration according to the target remote configuration mode.

In embodiments of the present disclosure, after selecting the target remote configuration mode according to the remote configuration mode supported by itself and the available remote configuration mode, the UE may perform the remote configuration according to the determined target remote configuration mode.

As an implementation of embodiments of the present disclosure, the UE determines that the target remote configuration mode is the UP remote configuration mode according to the remote configuration mode supported by itself and the available remote configuration mode, and then the UE may perform the remote configuration according to the UP remote configuration mode.

As another implementation of embodiments of the present disclosure, the UE determines that the target remote configuration mode is the CP remote configuration mode according to the remote configuration mode supported by itself and the available remote configuration mode, and then the UE may perform the remote configuration according to the CP remote configuration mode.

In the method for remotely configuring the UE in embodiments of the present disclosure, after the target remote configuration mode is determined through the remote configuration mode supported by the UE itself and the available remote configuration mode, the UE performs the remote configuration according to the target remote configuration mode, thereby realizing the purpose that the UE selects, from the UP remote configuration mode and the CP remote configuration mode, the appropriate configuration mode for the remote configuration.

In some embodiments of the present disclosure, the foregoing implementations may be executed individually or in combination, which is not limited in embodiments of the present disclosure.

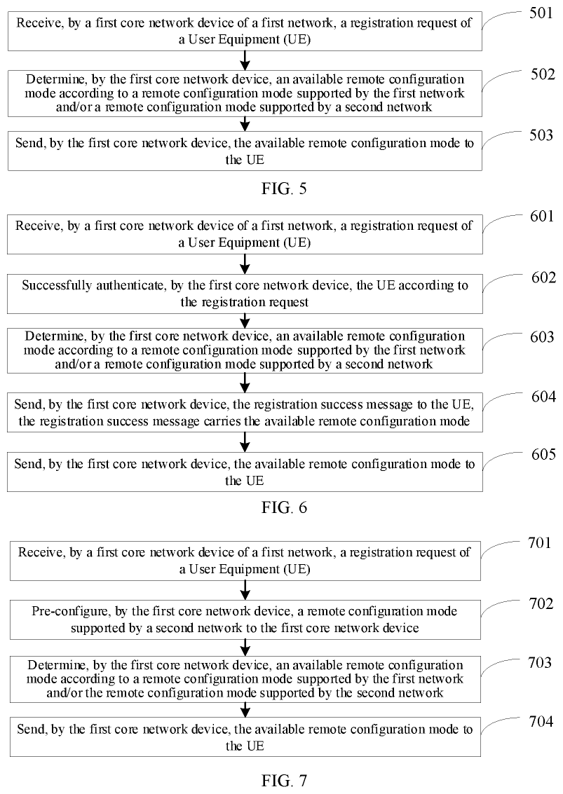

Embodiments of the present disclosure provide a method for determining a remote configuration mode, and FIG. 5 is a schematic flowchart of a method for determining a remote configuration mode provided by an embodiment of the present disclosure. The method for determining the remote configuration mode may be applied to a first core network device. The method for determining the remote configuration mode may be executed individually, or may be executed in combination with any embodiment or any implementation in embodiments in the present disclosure, or may be executed in combination with any technical solution in the related arts.

As shown in FIG. 5, the method for determining the remote configuration mode may include the following steps 501 to 503.

In the step 501, a first core network device of a first network receives a registration request of a User Equipment (UE).

The first network may be an O-SNPN, and the first core network device may be an AMF or a PCF.

In the step 502, the first core network device determines an available remote configuration mode according to a remote configuration mode supported by the first network and/or a remote configuration mode supported by a second network.

The remote configuration modes supported by the first network and the second network may include a UP remote configuration mode and/or a CP remote configuration mode.

In the step 503, the first core network device sends the available remote configuration mode to the UE.

In some embodiments of the present disclosure, the explanation of the remote configuration method performed on the UE side in any of the above-mentioned embodiments in FIGS. 1 to 4 is also applicable to the method for determining the remote configuration mode performed for the first core network device in embodiments, with the similar implementation principle, and will not be repeated here.

In the method for determining the remote configuration mode in embodiments of the present disclosure, upon determining the available remote configuration mode according to the remote configuration modes supported by the first network and/or the second network, the first core network device of the first network sends the available remote configuration mode to the UE, so that the UE can perform the remote configuration according to the received available remote configuration mode, thereby avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for determining a remote configuration mode, and FIG. 6 is a schematic flowchart of a method for determining a remote configuration mode provided by an embodiment of the present disclosure. The method for determining the remote configuration mode may be applied to a first core network device. The method for determining the remote configuration mode may be executed individually, or may be executed in combination with any embodiment or any implementation in embodiments in the present disclosure, or may be executed in combination with any technical solution in the related arts.

As shown in FIG. 6, the method for determining the remote configuration mode may include the following steps 601 to 605.

In the step 601, a first core network device of a first network receives a registration request of a User Equipment (UE).

The step 601 may be implemented by adopting any of various embodiments of the present disclosure, which is not limited in embodiments of the present disclosure, and will also not be repeated here.

In the step 602, the first core network device successfully authenticates the UE according to the registration request.

In embodiments of the present disclosure, after receiving the registration request sent by the UE, the first core network device may authenticate the received registration request to determine whether the registration is successful.

As an implementation of embodiments of the present disclosure, the first core network device authenticates the received registration request sent by the UE. When determining that the registration fails, the first core network device may send a registration failure message to the UE.

As another implementation of embodiments of the present disclosure, the first core network device authenticates the received registration request sent by the UE. When determining that the registration is successful, the first core network device may send a registration success message to the UE. The registration success message carries an available remote configuration mode.

The available remote configuration mode may be a UP remote configuration mode and/or a CP remote configuration mode.

In the step 603, the first core network device determines the available remote configuration mode according to a remote configuration mode supported by the first network and/or a remote configuration mode supported by a second network.

In the step 604, the first core network device sends the registration success message to the UE, and the registration success message carries the available remote configuration mode.

In the step 605, the first core network device sends the available remote configuration mode to the UE.

In some embodiments of the present disclosure, the explanation of the remote configuration method performed on the UE side in any of the above-mentioned embodiments in FIGS. 1 to 4 is also applicable to the method for determining the remote configuration mode performed for the first core network device in embodiments, with the similar implementation principle, and will not be repeated here.

In the method for determining the remote configuration mode in embodiments of the present disclosure, after successfully authenticating the received registration request sent by the UE, the first core network device can send to the UE the registration success message carrying the available remote configuration mode, so that the UE can perform the remote configuration according to the received available remote configuration mode, thereby avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for determining a remote configuration mode, and FIG. 7 is a schematic flowchart of another method for determining a remote configuration mode provided by an embodiment of the present disclosure. The method for determining the remote configuration mode may be applied to a first core network device. The method for determining the remote configuration mode may be executed individually, or may be executed in combination with any embodiment or any implementation in embodiments in the present disclosure, or may be executed in combination with any technical solution in the related arts.

As shown in FIG. 7, the method for determining the remote configuration mode may include the following steps 701 to 704.

In the step 701, a first core network device of a first network receives a registration request of a User Equipment (UE).

The step 701 may be implemented by adopting any of various embodiments of the present disclosure, which is not limited in embodiments of the present disclosure, and will also not be repeated here.

In the step 702, the first core network device pre-configures a remote configuration mode supported by a second network to the first core network device.

In embodiments of the present disclosure, the remote configuration mode supported by the second network may be a UP remote configuration mode, a CP remote configuration mode, or both the UP remote configuration mode and the CP remote configuration mode, which is not limited here.

In the step 703, the first core network device determines an available remote configuration mode according to a remote configuration mode supported by the first network and/or the remote configuration mode supported by the second network.

In the step 704, the first core network device sends the available remote configuration mode to the UE.

In some embodiments of the present disclosure, the explanation of the remote configuration method performed on the UE side in any of the above-mentioned embodiments in FIGS. 1 to 4 is also applicable to the method for determining the remote configuration mode performed for the first core network device in embodiments, with the similar implementation principle, and will not be repeated here.

In the method for determining the remote configuration mode in embodiments of the present disclosure, the first core network device pre-configures the remote configuration mode supported by the second network to the first core network device, and then determines the available remote configuration mode according to the remote configuration mode supported by the first network and/or the remote configuration mode supported by the second network, so as to send to the UE the available remote configuration mode, so that the UE can perform the remote configuration according to the received available remote configuration mode, thereby avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

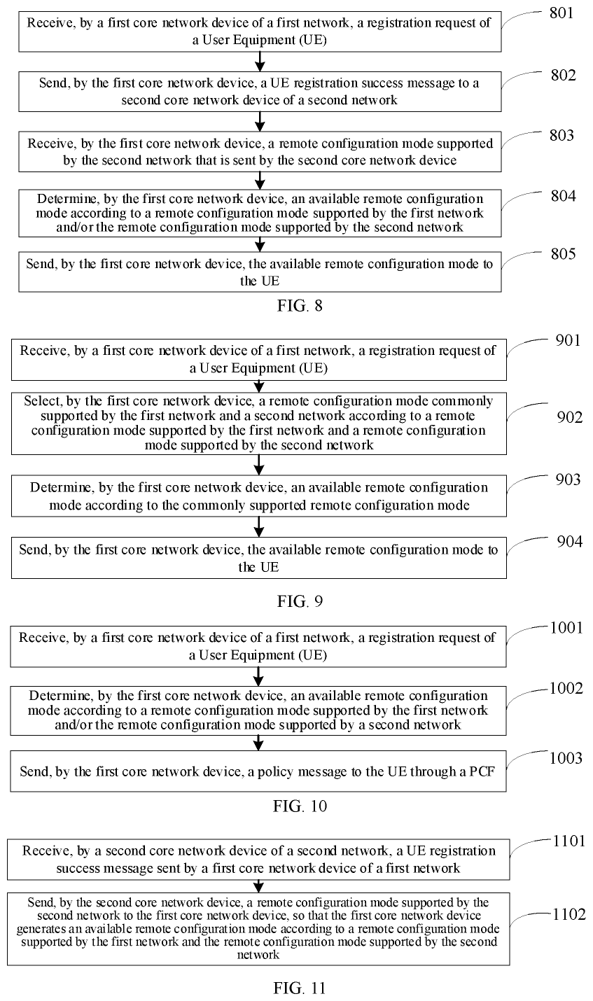

Embodiments of the present disclosure provide another method for determining a remote configuration mode, and FIG. 8 is a schematic flowchart of another method for determining a remote configuration mode provided by an embodiment of the present disclosure. The method for determining the remote configuration mode may be applied to a first core network device. The method for determining the remote configuration mode may be executed individually, or may be executed in combination with any embodiment or any implementation in embodiments in the present disclosure, or may be executed in combination with any technical solution in the related arts.

As shown in FIG. 8, the method for determining the remote configuration mode may include the following steps 801 to 805.

In the step 801, a first core network device of a first network receives a registration request of a User Equipment (UE).

The step 801 may be implemented by adopting any of various embodiments of the present disclosure, which is not limited in embodiments of the present disclosure, and will also not be repeated here.

In the step 802, the first core network device sends a UE registration success message to a second core network device of a second network.

In embodiments of the present disclosure, after receiving the registration request sent by the UE, the first core network device sends the UE registration success message to the second core network device of the second network when determining that the registration of the UE is successful.

The second network is a SO-SNPN.

In the step 803, the first core network device receives a remote configuration mode supported by the second network that is sent by the second core network device.

The remote configuration mode supported by the second network may be a UP remote configuration mode, a CP remote configuration mode, or both the UP remote configuration mode and the CP remote configuration mode, which is not limited here.

In embodiments of the present disclosure, after the first core network device sends the UE registration success message to the second core network device of the second network, the second core network device sends to the first core network device the remote configuration mode supported by the second network upon receiving the UE registration success message, so that the first core network device receives the remote configuration mode supported by the second network that is sent by the second core network device.

In the step 804, the first core network device determines an available remote configuration mode according to a remote configuration mode supported by the first network and/or the remote configuration mode supported by the second network.

In the step 805, the first core network device sends the available remote configuration mode to the UE.

In some embodiments of the present disclosure, the explanation of the remote configuration method performed on the UE side in any of the above-mentioned embodiments in FIGS. 1 to 4 is also applicable to the method for determining the remote configuration mode performed for the first core network device in embodiments, with the similar implementation principle, and will not be repeated here.

In the method for determining the remote configuration mode in embodiments of the present disclosure, after sending the UE registration success message to the second core network device of the second network, the first core network device receives the remote configuration mode supported by the second network that is sent by the second core network device, and then the first core network device determines the available remote configuration mode according to the remote configuration mode supported by the first network and/or the remote configuration mode supported by the second network, so as to send the available remote configuration mode to the UE, so that the UE can perform the remote configuration according to the received available remote configuration mode, thereby avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for determining a remote configuration mode, and FIG. 9 is a schematic flowchart of another method for determining a remote configuration mode provided by an embodiment of the present disclosure. The method for determining the remote configuration mode may be applied to a first core network device. The method for determining the remote configuration mode may be executed individually, or may be executed in combination with any embodiment or any implementation in embodiments in the present disclosure, or may be executed in combination with any technical solution in the related arts.

As shown in FIG. 9, the method for determining the remote configuration mode may include the following steps 901 to 904.

In the step 901, a first core network device of a first network receives a registration request of a User Equipment (UE).

The step 901 may be implemented by adopting any of various embodiments of the present disclosure, which is not limited in embodiments of the present disclosure, and will also not be repeated here.

In the step 902, the first core network device selects a remote configuration mode commonly supported by the first network and a second network according to a remote configuration mode supported by the first network and a remote configuration mode supported by the second network.

The first network is an O-SNPN, and the second network is a SO-SNPN.

In embodiments of the present disclosure, upon determining the remote configuration mode supported by the first network and the remote configuration mode supported by the second network, the first core network device may determine the remote configuration mode commonly supported by the first network and the second network.

As an implementation of embodiments of the present disclosure, the remote configuration mode supported by the first network is a UP remote configuration mode and a CP remote configuration mode, and the remote configuration mode supported by the second network is the UP remote configuration mode, then it can be determined that the remote configuration mode commonly supported by the first network and the second network is the UP remote configuration mode.

As another implementation of embodiments of the present disclosure, the remote configuration mode supported by the first network is the UP remote configuration mode and the CP remote configuration mode, and the remote configuration mode supported by the second network is the CP remote configuration mode, then it can be determined that the remote configuration mode commonly supported by the first network and the second network is the CP remote configuration mode.

As another implementation of embodiments of the present disclosure, the remote configuration mode supported by the first network is the UP remote configuration mode, and the remote configuration mode supported by the second network is the UP remote configuration and the CP remote configuration mode, then it can be determined that the remote configuration mode commonly supported by the first network and the second network is the UP remote configuration mode.

As another implementation of embodiments of the present disclosure, the remote configuration mode supported by the first network is the CP remote configuration mode, and the remote configuration mode supported by the second network is the UP remote configuration and the CP remote configuration mode, then it can be determined that the remote configuration mode commonly supported by the first network and the second network is the CP remote configuration mode.

As another implementation of embodiments of the present disclosure, the remote configuration mode supported by the first network is the UP remote configuration mode and the CP remote configuration mode, and the remote configuration mode supported by the second network is also the UP remote configuration and the CP remote configuration mode, then it can be determined that the remote configuration mode commonly supported by the first network and the second network is the UP remote configuration mode and the CP remote configuration mode.

In the step 903, the first core network device determines an available remote configuration mode according to the commonly supported remote configuration mode.

In embodiments of the present disclosure, after determining the remote configuration mode commonly supported by the first network and the second network, the first core network device may determine the available remote configuration mode according to the commonly supported remote configuration mode.

As an implementation of embodiments of the present disclosure, the remote configuration mode commonly supported by the first network and the second network is the UP remote configuration mode, and the first core network device may determine that the available remote configuration mode is the UP remote configuration mode.

As another implementation of embodiments of the present disclosure, the remote configuration mode commonly supported by the first network and the second network is the CP remote configuration mode, and the first core network device may determine that the available remote configuration mode is the CP remote configuration mode.

As another implementation of embodiments of the present disclosure, the remote configuration mode commonly supported by the first network and the second network is the UP remote configuration mode and the CP remote configuration mode, and the first core network device may determine that the available remote configuration mode is the UP remote configuration mode and the CP remote configuration mode.

In embodiments of the present disclosure, when the first core network device determines that the remote configuration mode commonly supported by the first network and the second network is the UP remote configuration mode and the CP remote configuration mode, the available remote configuration mode can be selected from the commonly supported UP remote configuration mode and CP remote configuration mode according to the obtained pre-configuration policy message and/or network parameter information. In this way, when the UE supports both the UP remote configuration mode and the CP remote configuration mode, an applicable remote configuration mode can be selected therefrom for the remote configuration.

In some embodiments of the present disclosure, after determining the remote configuration mode commonly supported by the first network and the second network, the first core network device can determine, upon obtaining the pre-configuration policy message, the available remote configuration mode from the remote configuration mode commonly supported by the first network and the second network according to the pre-configuration policy message.

For example, the first core network device determines that the remote configuration mode commonly supported by the first network and the second network is the UP remote configuration mode and the CP remote configuration mode, and determines that the available remote configuration mode is the CP remote configuration mode according to the pre-configuration policy message.

In some embodiments of the present disclosure, after determining the remote configuration mode commonly supported by the first network and the second network, the first core network device can determine, upon obtaining the network parameter information, the available remote configuration mode from the remote configuration mode commonly supported by the first network and the second network according to the network parameter information.

The network parameter information includes one or more of network load information of the first network and/or the second network, and network capability information.

In some embodiments of the present disclosure, after determining the remote configuration mode commonly supported by the first network and the second network, the first core network device can determine, upon obtaining the pre-configuration policy message and the network parameter information, the available remote configuration mode from the remote configuration mode commonly supported by the first network and the second network according to both the pre-configuration policy message and the network parameter information.

As an implementation of embodiments of the present disclosure, if the first core network device fails to determine the available remote configuration mode, it sends to the UE a message that the remote configuration is not supported.

In the step 904, the first core network device sends the available remote configuration mode to the UE.

The step 904 may be implemented by adopting any of various embodiments of the present disclosure, which is not limited in embodiments of the present disclosure, and will also not be repeated here.

In the method for determining the remote configuration mode in embodiments of the present disclosure, the first core network device selects the remote configuration mode commonly supported by the first network and the second network according to the remote configuration mode supported by the first network and the remote configuration mode supported by the second network, and determines the available remote configuration mode according to the commonly supported remote configuration mode, so as to send the available remote configuration mode to the UE, so that the UE can perform the remote configuration according to the received available remote configuration mode, thereby avoiding the technical problem of failing to determine the remote configuration mode actually adopted in the remote configuration process for the UE when the first network and the second network support a plurality of remote configuration modes in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for determining a remote configuration mode, and FIG. 10 is a schematic flowchart of another method for determining a remote configuration mode provided by an embodiment of the present disclosure. The method for determining the remote configuration mode may be applied to a first core network device. The method for determining the remote configuration mode may be executed individually, or may be executed in combination with any embodiment or any implementation in embodiments in the present disclosure, or may be executed in combination with any technical solution in the related arts.

As shown in FIG. 10, the method for determining the remote configuration mode may include the following steps 1001 to 1003.

In the step 1001, a first core network device of a first network receives a registration request of a User Equipment (UE).

In the step 1002, the first core network device determines an available remote configuration mode according to a remote configuration mode supported by the first network and/or a remote configuration mode supported by a second network.

In the step 1003, the first core network device sends a policy message to the UE through a PCF.

The policy message carries the available remote configuration mode.

In some embodiments of the present disclosure, the explanation of the remote configuration method performed on the UE side in any of the above-mentioned embodiments in FIGS. 1 to 4 is also applicable to the method for determining the remote configuration mode performed for the first core network device in embodiments, with the similar implementation principle, and will not be repeated here.

In the method for determining the remote configuration mode in embodiments of the present disclosure, the first core network device of the first network sends through the PCF the policy message carrying the available remote configuration mode to the UE, so that after receiving the policy message, the UE can perform the remote configuration according to the available remote configuration mode carried in the policy message.

In some embodiments of the present disclosure, the foregoing implementations may be executed individually or in combination, which is not limited in embodiments of the present disclosure.

Embodiments of the present disclosure provide another method for determining a remote configuration mode, and FIG. 11 is a schematic flowchart of another method for determining a remote configuration mode provided by an embodiment of the present disclosure. The method for determining the remote configuration mode may be applied to a second core network device. The method for determining the remote configuration mode may be executed individually, or may be executed in combination with any embodiment or any implementation in embodiments in the present disclosure, or may be executed in combination with any technical solution in the related arts.

As shown in FIG. 11, the method for determining the remote configuration mode may include the following steps 1101 to 1102.

In the step 1101, a second core network device of a second network receives a UE registration success message sent by a first core network device of a first network.

The first network is an O-SNPN, and the second network is a SO-SNPN.

In the step 1102, the second core network device sends a remote configuration mode supported by the second network to the first core network device, so that the first core network device generates an available remote configuration mode according to a remote configuration mode supported by the first network and the remote configuration mode supported by the second network.

The steps 1101 to 1102 may be implemented by adopting any of various embodiments of the present disclosure, respectively, which are not limited in embodiments of the present disclosure, and will also not be repeated here.

In the method for determining the remote configuration mode in embodiments of the present disclosure, after receiving the UE registration success message sent by the first core network device of the first network, the second core network device sends the remote configuration mode supported by the second network to the first core network device, so that the first core network device generates the available remote configuration mode according to the remote configuration mode supported by the first network and the remote configuration mode supported by the second network. In this way, it is realized that the available remote configuration mode is generated according to the remote configuration modes supported by the first network and the second network, so that the UE performs the remote configuration according to the available remote configuration mode.

In some embodiments of the present disclosure, the foregoing implementations may be executed individually or in combination, which is not limited in embodiments of the present disclosure.

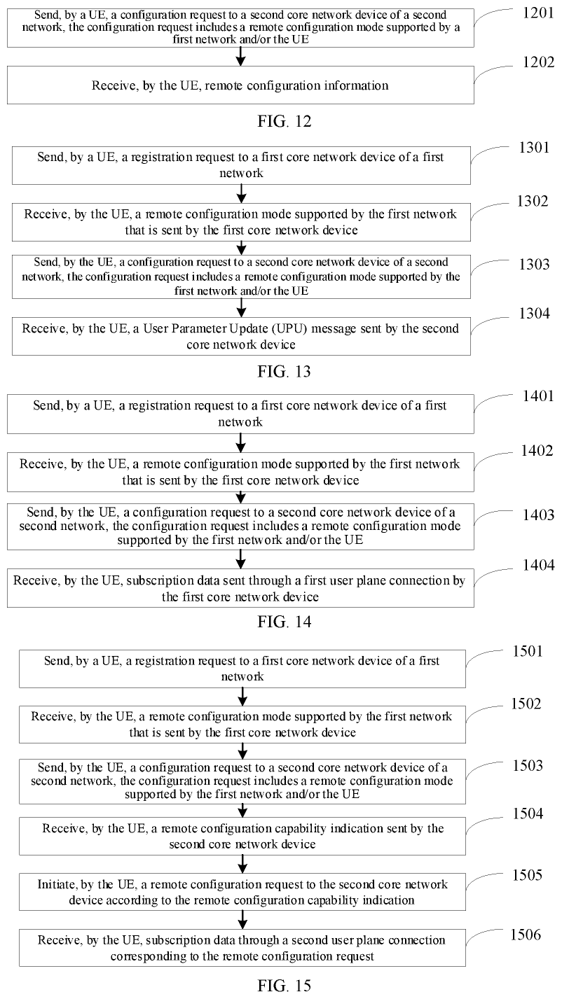

Embodiments of the present disclosure provide another method for remotely configuring a UE, and FIG. 12 is a schematic flowchart of another method for remotely configuring a UE provided by an embodiment of the present disclosure. The remote configuration method can be applied to the UE. The remote configuration method may be executed individually, or may be executed in combination with any embodiment or any implementation in embodiments in the present disclosure, or may be executed in combination with any technical solution in the related arts.

As shown in FIG. 12, the remote configuration method may include the following steps 1201 to 1202.

In the step 1201, the UE sends a configuration request to a second core network device of a second network, and the configuration request includes a remote configuration mode supported by a first network and/or the UE.

The second network is a SO-SNPN, and the second core network device may be an AMF or a PCF.

In embodiments of the present disclosure, after receiving the remote configuration mode supported by the first network that is sent by a first core network device, the UE may send, to the second core network device of the second network, the configuration request including the remote configuration mode supported by the first network and/or the UE.

In some embodiments of the present disclosure, the configuration request sent by the UE to the second core network device of the second network may include the remote configuration mode supported by the first network.

In some embodiments of the present disclosure, the configuration request sent by the UE to the second core network device of the second network may include the remote configuration mode supported by the UE.

In some embodiments of the present disclosure, the configuration request sent by the UE to the second core network device of the second network may further include the remote configuration mode supported by both the first network and the UE.

The remote configuration mode supported by both the first network and/or the UE includes a UP remote configuration mode and/or a CP remote configuration mode.

As an implementation of embodiments of the present disclosure, the remote configuration mode supported by both the first network and the UE is the UP remote configuration mode, and the UE sends the configuration request including the UP remote configuration mode to the second core network device of the second network.

As another implementation of embodiments of the present disclosure, the remote configuration mode supported by both the first network and the UE is the CP remote configuration mode, and the UE sends the configuration request including the CP remote configuration mode to the second core network device of the second network.

As another implementation of embodiments of the present disclosure, the remote configuration mode supported by both the first network and the UE is the UP remote configuration mode and the CP remote configuration mode, and the UE sends the configuration request including the UP remote configuration mode and the CP remote configuration mode to the second core network device of the second network. In the step 1202, the UE receives remote configuration information.

As an implementation of embodiments of the present disclosure, the UE may receive the remote configuration information sent by the first core network device.

As another implementation of embodiments of the present disclosure, the UE may receive the remote configuration information sent by the second core network device.

In the method for remotely configuring the UE in embodiments of the present disclosure, the UE sends the configuration request to the second core network device of the second network, and the configuration request includes the remote configuration mode supported by the first network and/or the UE; and the UE receives the remote configuration information. In this way, when the first network and the second network do not determine the available remote configuration mode in advance, the UE can determine the remote configuration information through negotiation, solving the technical problem of failing to determine the remote configuration mode actually adopted in the remote configuration process for the UE when the first network and the second network support a plurality of remote configuration modes in the prior art, and improving the flexibility and usability of the remote configuration for the UE.

In some embodiments of the present disclosure, the foregoing implementations may be executed individually or in combination, which is not limited in embodiments of the present disclosure.

Embodiments of the present disclosure provide another method for remotely configuring a UE, and FIG. 13 is a schematic flowchart of another method for remotely configuring a UE provided by an embodiment of the present disclosure. The remote configuration method can be applied to the UE. The remote configuration method may be executed individually, or may be executed in combination with any embodiment or any implementation in embodiments in the present disclosure, or may be executed in combination with any technical solution in the related arts.

As shown in FIG. 13, the remote configuration method may include the following steps 1301 to 1304.

In the step 1301, the UE sends a registration request to a first core network device of a first network.

The first network may be an O-SNPN, and the first core network device may be an AMF or a PCF.

In the step 1302, the UE receives a remote configuration mode supported by the first network that is sent by the first core network device.

In embodiments of the present disclosure, in a case that remote configuration modes supported by the first network and a second network are not negotiated in advance, the UE may send the registration request to the first core network device of the first network to receive the remote configuration mode supported by the first network that is sent to the UE by the first core network device after the determination of the successful registration.

The remote configuration mode supported by the first network may be the UP remote configuration mode, the CP remote configuration mode, or both the UP remote configuration mode and the CP remote configuration mode, which are not limited here.

In the step 1303, the UE sends a configuration request to a second core network device of a second network, and the configuration request includes a remote configuration mode supported by the first network and/or the UE.

In the step 1304, the UE receives a Non-Access Stratum (NAS) message sent by the second core network device, and the NAS message carries a configuration parameter.

The NAS message is a general term for message signalings, and may include a UPU message.

As an implementation of embodiments of the present disclosure, after the UE sends the remote configuration mode supported by both the first network and the UE to the second core network device, the second core network device sends the NAS message to the UE when determining to remotely control the UE by means of the CP remote control mode.

In some embodiments of the present disclosure, the UPU message is that the first core network device sends subscription data of the second core network device to the UE side.

In the method for remotely configuring the UE in embodiments of the present disclosure, the UE sends the registration request to the first core network device of the first network; the UE receives the remote configuration mode supported by the first network that is sent by the first core network device; the UE sends the configuration request to the second core network device of the second network, and the configuration request includes the remote configuration mode supported by the first network and/or the UE; and the UE receives the NAS message sent by the second core network device. In this way, after the available remote configuration mode is determined according to the remote configuration mode supported by both the first core network device and the UE, the NAS message carrying the configuration parameter is sent to the UE, so that the UE can perform the remote configuration according to the received available remote configuration mode.

In some embodiments of the present disclosure, the foregoing implementations may be executed individually or in combination, which is not limited in embodiments of the present disclosure.

Embodiments of the present disclosure provide another method for remotely configuring a UE, and FIG. 14 is a schematic flowchart of another method for remotely configuring a UE provided by an embodiment of the present disclosure. The remote configuration method can be applied to the UE. The remote configuration method may be executed individually, or may be executed in combination with any embodiment or any implementation in embodiments in the present disclosure, or may be executed in combination with any technical solution in the related arts.

As shown in FIG. 14, the remote configuration method may include the following steps 1401 to 1404.

In the step 1401, the UE sends a registration request to a first core network device of a first network.

In the step 1402, the UE receives a remote configuration mode supported by the first network that is sent by the first core network device.

In the step 1403, the UE sends a configuration request to a second core network device of a second network, and the configuration request includes a remote configuration mode supported by the first network and/or the UE.

The steps 1401 to 1403 may be implemented by adopting any of various embodiments of the present disclosure, respectively, which are not limited in embodiments of the present disclosure, and will also not be repeated here.

In the step 1404, the UE receives subscription data sent through a first user plane connection by the first core network device.

In embodiments of the present disclosure, the remote configuration information received by the UE includes the subscription data.

As an implementation of embodiments of the present disclosure, the UE sends the configuration request to the second core network device, and when determining to adopt the UP remote configuration mode, the second core network device triggers, through a signaling, the first core network device to establish the first user plane connection. Further, the first core network device sends the subscription data to the UE through the first user plane connection, so that the UE receives the subscription data.

The first user plane connection, that is, a specific Protocol Data Unit (PDU) session, is dedicated to the remote configuration.

In the method for remotely configuring the UE in embodiments of the present disclosure, the UE sends the registration request to the first core network device of the first network; the UE receives the remote configuration mode supported by the first network that is sent by the first core network device; the UE sends the configuration request to the second core network device of the second network, and the configuration request includes the remote configuration mode supported by the first network and/or the UE; and the UE receives the subscription data sent through the first user plane connection by the first core network device. In this way, after it is determined that the available remote configuration mode is the UP remote configuration mode according to the remote configuration mode supported by both the first core network device and the UE, the subscription data is sent to the UE, so that the UE can perform the remote configuration according to the received subscription data.

In some embodiments of the present disclosure, the foregoing implementations may be executed individually or in combination, which is not limited in embodiments of the present disclosure.

Embodiments of the present disclosure provide another method for remotely configuring a UE, and FIG. 15 is a schematic flowchart of another method for remotely configuring a UE provided by an embodiment of the present disclosure. The remote configuration method can be applied to the UE. The remote configuration method may be executed individually, or may be executed in combination with any embodiment or any implementation in embodiments in the present disclosure, or may be executed in combination with any technical solution in the related arts.

As shown in FIG. 15, the remote configuration method may include the following steps 1501 to 1506.

In the step 1501, the UE sends a registration request to a first core network device of a first network.

In the step 1502, the UE receives a remote configuration mode supported by the first network that is sent by the first core network device.

In the step 1503, the UE sends a configuration request to a second core network device of a second network, and the configuration request includes a remote configuration mode supported by the first network and/or the UE.

The steps 1501 to 1503 may be implemented by adopting any of various embodiments of the present disclosure, respectively, which are not limited in embodiments of the present disclosure, and will also not be repeated here.

In the step 1504, the UE receives a remote configuration capability indication sent by the second core network device.

In embodiments of the present disclosure, when it is determined that the remote configuration mode supported by the first core network device and/or the UE is the UP remote configuration mode, the second core network device may feed back the remote configuration capability indication to the UE, so that the UE receives the remote configuration capability indication sent by the second core network device.

In the step 1505, the UE initiates a remote configuration request to the second core network device according to the remote configuration capability indication.

In embodiments of the present disclosure, after receiving the remote configuration capability indication sent by the second core network device, the UE sends the remote configuration request to the second core network device according to the remote configuration capability indication, so as to initiate a remote configuration process on the user plane.

In the step 1506, the UE receives subscription data through a second user plane connection corresponding to the remote configuration request.

In embodiments of the present disclosure, after the UE initiates the remote configuration request to the second core network device according to the remote configuration capability indication, the subscription data may be sent to the UE through the second user plane connection established by the first core network device, so that the UE receives the subscription data.

In the method for remotely configuring the UE in embodiments of the present disclosure, the UE sends the registration request to the first core network device of the first network; the UE receives the remote configuration mode supported by the first network that is sent by the first core network device; the UE sends the configuration request to the second core network device of the second network, and the configuration request includes the remote configuration mode supported by the first network and/or the UE; and the UE receives the subscription data sent through the second user plane connection. In this way, after it is determined that the remote configuration mode supported by both the first core network device and the UE is the UP remote configuration mode, the UE obtains the subscription data according to the established remote configuration request, so that the UE can perform the remote configuration according to the received subscription data.

In some embodiments of the present disclosure, the foregoing implementations may be executed individually or in combination, which is not limited in embodiments of the present disclosure.

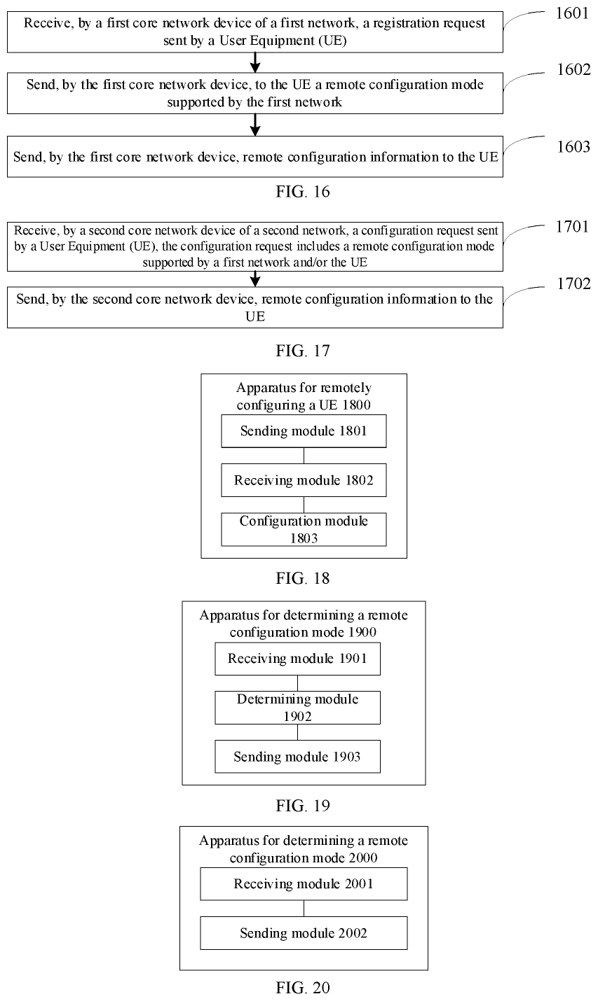

Embodiments of the present disclosure provide another method for determining a remote configuration mode, and FIG. 16 is a schematic flowchart of another method for determining a remote configuration mode provided by an embodiment of the present disclosure. The method for determining the remote configuration mode may be applied to a first core network device. The method for determining the remote configuration mode may be executed individually, or may be executed in combination with any embodiment or any implementation in embodiments in the present disclosure, or may be executed in combination with any technical solution in the related arts.

As shown in FIG. 16, the method for determining the remote configuration mode may include the following steps 1601 to 1603.

In the step 1601, a first core network device of a first network receives a registration request sent by a User Equipment (UE).

The first network is an O-SNPN, and the first core network device is an AMF or a PCF.

In the step 1602, the first core network device sends to the UE a remote configuration mode supported by the first network.

The remote configuration mode supported by the first network may be a UP remote configuration mode and/or a CP remote configuration mode.

In the step 1603, the first core network device sends remote configuration information to the UE.

As an implementation of embodiments of the present disclosure, the remote configuration information may include a configuration parameter, and the first core network device sends a User Parameter Update (UPU) message to a second core network device of a second network, the UPU message includes the configuration parameter.

As another implementation of embodiments of the present disclosure, the remote configuration information includes subscription data, and the first core network device sends the subscription data to the UE through a first user plane connection.

In some embodiments of the present disclosure, the explanation of the remote configuration method performed on the UE side in any of the above-mentioned embodiments in FIGS. 12 to 15 is also applicable to the method for determining the remote configuration mode performed for the first core network device in embodiments, with the similar implementation principle, and will not be repeated here.

In the method for remotely configuring the UE in embodiments of the present disclosure, the first core network device of the first network receives the registration request sent by the UE; the first core network device sends the remote configuration mode supported by the first network to the UE; and the first core network device sends the remote configuration information to the UE. In this way, the first core network device sends the remote configuration information to the UE side, so that the UE performs the remote configuration, which realizes that when there is a plurality of remote configuration modes, the UE can perform the remote configuration by using an applicable remote configuration mode.

In some embodiments of the present disclosure, the foregoing implementations may be executed individually or in combination, which is not limited in embodiments of the present disclosure.

Embodiments of the present disclosure provide another method for determining a remote configuration mode, and FIG. 17 is a schematic flowchart of another method for determining a remote configuration mode provided by an embodiment of the present disclosure. The method for determining the remote configuration mode may be applied to a second core network device. The method for determining the remote configuration mode may be executed individually, or may be executed in combination with any embodiment or any implementation in embodiments in the present disclosure, or may be executed in combination with any technical solution in the related arts.

As shown in FIG. 17, the method for determining the remote configuration mode may include the following steps 1701 to 1702.

In the step 1701, a second core network device of a second network receives a configuration request sent by a User Equipment (UE), and the configuration request includes a remote configuration mode supported by a first network and/or the UE.

The remote configuration mode supported by the first network and/or the UE may be a UP remote configuration mode and/or a CP remote configuration mode. The second network is a SO-SNPN.

In some embodiments of the present disclosure, the second core network device may be an AMF or a PCF.

In the step 1702, the second core network device sends remote configuration information to the UE.

As an implementation of embodiments of the present disclosure, the remote configuration information may include a configuration parameter. In this case, the second core network device receives the remote configuration request message sent by a first core network device of the first network, and sends the remote configuration information to the UE, the remote configuration information carries subscription data.

As another implementation of embodiments of the present disclosure, the remote configuration information may further include the subscription data. In this case, the second core network device sends a remote configuration capability indication to the UE, receives the remote configuration request sent, according to the remote configuration capability indication, by the UE, and sends the subscription data to the UE through a second user plane connection corresponding to the remote configuration request.

In some embodiments of the present disclosure, the explanation of the remote configuration method performed on the UE side in any of the above-mentioned embodiments in FIGS. 12 to 15 is also applicable to the method for determining the remote configuration mode for the second core network device in embodiments, with the similar implementation principle, and will not be repeated here.

In the method for determining the remote configuration mode in embodiments of the present disclosure, the second core network device of the second network receives the configuration request sent by the UE, and the configuration request includes the remote configuration mode supported by the first network and/or the UE; and the second core network device sends the remote configuration information to the UE. In this way, the second core network device sends the remote configuration information to the UE side, so that the UE performs the remote configuration, so that the UE performs the remote configuration, which realizes that when there is a plurality of remote configuration modes, the UE can perform the remote configuration by using an applicable remote configuration mode.

In some embodiments of the present disclosure, the foregoing implementations may be executed individually or in combination, which is not limited in embodiments of the present disclosure.

Corresponding to the method for remotely configuring the UE provided by embodiments of FIGS. 1 to 4 as described above, the present disclosure further provides an apparatus for remotely configuring a User Equipment (UE). Since the apparatus for remotely configuring the UE provided by embodiments of the present disclosure corresponds to the method for remotely configuring the UE provided by embodiments of FIGS. 1 to 4 as described above, implementations of the method for remotely configuring the UE are also applicable to the apparatus for remotely configuring the UE provided by embodiments of the present disclosure, which are not described in details in embodiments of the present disclosure.

FIG. 18 is a schematic structural diagram of an apparatus for remotely configuring a User Equipment (UE) provided by an embodiment of the present disclosure. The apparatus may be applied in the user equipment.

As shown in FIG. 18, the apparatus 1800 for remotely configuring the UE may include: a sending module 1801, a receiving module 1802 and a configuration module 1803.

The sending module 1801 is configured to send a registration request to a first core network device of a first network.

The receiving module 1802 is configured to receive an available remote configuration mode sent by the first core network device, and the available remote configuration mode is determined by a remote configuration mode supported by the first network and/or a remote configuration mode supported by a second network.

The configuration module 1803 is configured to perform remote configuration according to the available remote configuration mode.

In some embodiments of the present disclosure, the receiving module 1802 may further be configured to receive a registration response message sent by the first core network device, and if the registration response message is a registration success message, the available remote configuration mode is carried in the registration response message.

In some embodiments of the present disclosure, the receiving module 1802 may further be configured to receive a policy message sent through a Policy Control Function (PCF) by the first core network device, and the available remote configuration mode is carried in the policy message.

In some embodiments of the present disclosure, the configuration module 1803 may further be configured to: obtain a remote configuration mode supported by the UE; select a target remote configuration mode according to the remote configuration mode supported by the UE and the available remote configuration mode; and perform the remote configuration according to the target remote configuration mode.

In some embodiments of the present disclosure, the available remote configuration mode includes a User Plane (UP) remote configuration mode and/or a Control Plane (CP) remote configuration mode.

In some embodiments of the present disclosure, the first core network device is an Access and Mobility Management Function (AMF) or a PCF.

In some embodiments of the present disclosure, the first network is an Onboarding Standalone Non-Public Network (O-SNPN), and the second network is a Subscription Owner Standalone Non-Public Network (SO-SNPN).

In the apparatus for remotely configuring the UE in embodiments of the present disclosure, the UE sends the registration request to the first core network device of the first network; and upon receiving the available remote configuration mode sent by the first core network device, the UE performs the remote configuration according to the available remote configuration mode. Since the available remote configuration mode is determined according to the remote configuration modes supported by the first network and/or the second network, it is realized that the UE performs the remote configuration by selecting the remote configuration mode supported by itself from the available remote configuration mode, avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Corresponding to the method for determining the remote configuration mode provided by embodiments of FIGS. 5 to 10 as described above, the present disclosure further provides an apparatus for determining a remote configuration mode. Since the apparatus for determining the remote configuration mode provided by embodiments of the present disclosure corresponds to the method for determining the remote configuration mode provided by embodiments of FIGS. 5 to 10 as described above, implementations of the method for determining the remote configuration mode are also applicable to the apparatus for determining the remote configuration mode provided by embodiments of the present disclosure, which are not described in details in embodiments of the present disclosure.

FIG. 19 is a schematic structural diagram of an apparatus for determining a remote configuration mode provided by an embodiment of the present disclosure. The apparatus may be applied in a first core network device.

As shown in FIG. 19, the apparatus 1900 for determining the remote configuration mode may include: a receiving module 1901, a determining module 1902 and a sending module 1903.

The receiving module 1901 is configured to receive a registration request of a UE.

The determining module 1902 is configured to determine an available remote configuration mode according to a remote configuration mode supported by the first network and a remote configuration mode supported by a second network.

The sending module 1903 is configured to send the available remote configuration mode to the UE.

In some embodiments of the present disclosure, the apparatus 1900 for determining the remote configuration mode may further include: a pre-configuration module, configured to preconfigure the remote configuration mode supported by the second network to the first core network device.

In some embodiments of the present disclosure, the apparatus 1900 for determining the remote configuration mode may further include: a second sending module, configured to send a UE registration success message to a second core network device of the second network; and

a second receiving module, configured to receive the remote configuration mode supported by the second network that is sent by the second core network device.

In some embodiments of the present disclosure, the determining module 1902 may further be configured to: select a remote configuration mode commonly supported by the first network and the second network according to the remote configuration mode supported by the first network and the remote configuration mode supported by the second network; and determine the available remote configuration mode according to the commonly supported remote configuration mode

In some embodiments of the present disclosure, the determining module 1902 may further be configured to obtain a pre-configuration policy message and/or network parameter information; and select the available remote configuration mode from the commonly supported remote configuration mode according to the pre-configuration policy message and/or the network parameter information.

In some embodiments of the present disclosure, the network parameter information includes one or more of network load information and network capability information of the first network and/or the second network.

In some embodiments of the present disclosure, the sending module 1903 is further configured to send a registration success message to the UE, and the available remote configuration mode is carried in the registration success message.

In some embodiments of the present disclosure, the sending module 1903 may further be configured to send a policy message to the UE through a PCF, and the available remote configuration mode is carried in the policy message.

In some embodiments of the present disclosure, a remote configuration mode supported by the first network and the second network includes a UP remote configuration mode and/or a CP remote configuration mode.

In some embodiments of the present disclosure, the first network is an O-SNPN, and the second network is a SO-SNPN.

In some embodiments of the present disclosure, the first core network device is an AMF or a PCF.

In the apparatus for determining the remote configuration mode in embodiments of the present disclosure, upon determining the available remote configuration mode according to the remote configuration modes supported by the first network and/or the second network, the first core network device of the first network sends the available remote configuration mode to the UE, so that the UE can perform the remote configuration according to the received available remote configuration mode, thereby avoiding the technical problem of failing to determine the remote configuration mode adopted in the remote configuration process for the UE in the prior art, and improving the flexibility and usability of the remote configuration for the UE.

In some embodiments of the present disclosure, the foregoing implementations may be executed individually or in combination, which is not limited in embodiments of the present disclosure.

Corresponding to the method for determining the remote configuration mode provided by embodiments of FIG. 11 as described above, the present disclosure further provides an apparatus for determining a remote configuration mode. Since the apparatus for determining the remote configuration mode provided by embodiments of the present disclosure corresponds to the method for determining the remote configuration mode provided by embodiments of FIG. 11 as described above, implementations of the method for determining the remote configuration mode are also applicable to the apparatus for determining the remote configuration mode provided by embodiments of the present disclosure, which are not described in details in embodiments of the present disclosure.

FIG. 20 is a schematic structural diagram of another apparatus for determining a remote configuration mode provided by an embodiment of the present disclosure. The apparatus may be applied in a second core network device.

As shown in FIG. 20, the apparatus 2000 for determining the remote configuration mode may include: a receiving module 2001 and a sending module 2002.

The receiving module 2001 is configured to receive a UE registration success message sent by a first core network device of a first network.

The sending module 2002 is configured to send a remote configuration mode supported by the second network to the first core network device, so that an available remote configuration mode is generated by the first core network device according to a remote configuration mode supported by the first network and the remote configuration mode supported by the second network.

In some embodiments of the present disclosure, the first network is an O-SNPN, and the second network is a SO-SNPN.

In the apparatus for determining the remote configuration mode in embodiments of the present disclosure, after receiving the UE registration success message sent by the first core network device of the first network, the second core network device sends the remote configuration mode supported by the second network to the first core network device, so that the first core network device generates the available remote configuration mode according to the remote configuration mode supported by the first network and the remote configuration mode supported by the second network. In this way, it is realized that the available remote configuration mode is generated according to the remote configuration modes supported by the first network and the second network, so that the UE performs the remote configuration according to the available remote configuration mode.

In some embodiments of the present disclosure, the foregoing implementations may be executed individually or in combination, which is not limited in embodiments of the present disclosure.

Corresponding to the method for remotely configuring the UE provided by embodiments of FIGS. 12 to 15 as described above, the present disclosure further provides another apparatus for remotely configuring a User Equipment (UE). Since the apparatus for remotely configuring the UE provided by embodiments of the present disclosure corresponds to the method for remotely configuring the UE provided by embodiments of FIGS. 12 to 15 as described above, implementations of the method for remotely configuring the UE are also applicable to the apparatus for remotely configuring the UE provided by embodiments of the present disclosure, which are not described in details in embodiments of the present disclosure.

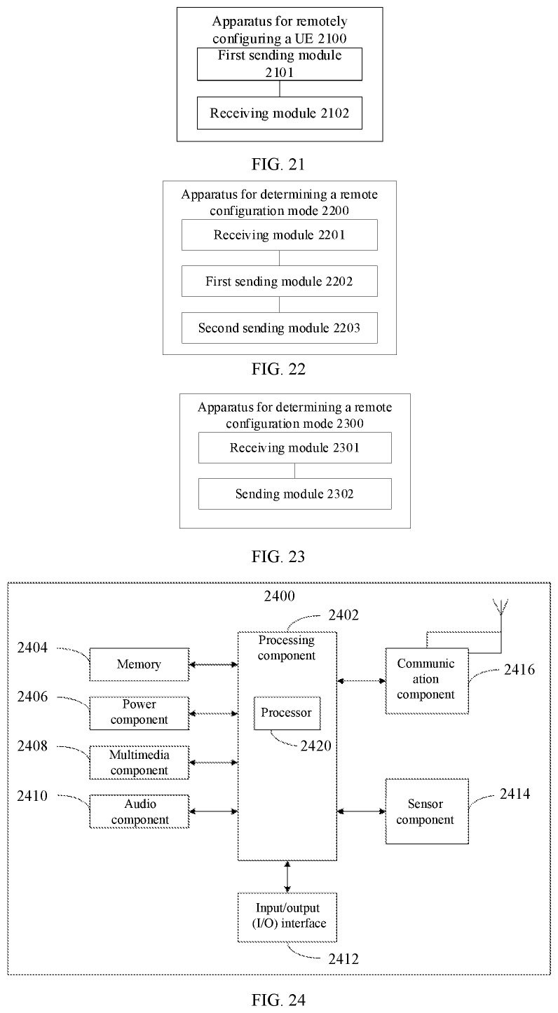

FIG. 21 is a schematic structural diagram of another apparatus for remotely configuring a User Equipment (UE) provided by an embodiment of the present disclosure. The apparatus may be applied in the user equipment.

As shown in FIG. 21, the apparatus 2100 for remotely configuring the UE may include: a first sending module 2101 and a receiving module 2102.

The first sending module 2101 is configured to send a configuration request to a second core network device of a second network, and the configuration request includes a remote configuration mode supported by a first network and/or the UE.

The receiving module 2102 is configured to receive remote configuration information.

In some embodiments of the present disclosure, the apparatus 2100 for remotely configuring the UE may further include: a second sending module, configured to send a registration request to a first core network device of the first network.

The receiving module is configured to receive the remote configuration mode supported by the first network that is sent by the first core network device.

In some embodiments of the present disclosure, the remote configuration information may include a configuration parameter, and the receiving module 2102 may further be configured to receive a Non-Access Stratum (NAS) message sent by the second core network device, and the configuration parameter is carried in the NAS message.

In some embodiments of the present disclosure, the remote configuration information may further include subscription data, and the receiving module 2102 may further be configured to receive the subscription data sent through a first user plane connection by a first core network device.

In some embodiments of the present disclosure, the remote configuration information may further include subscription data, and the receiving module 2102 may further be configured to receive a remote configuration capability indication sent by the second core network device; initiate a remote configuration request to the second core network device according to the remote configuration capability indication; and receive the subscription data through a second user plane connection corresponding to the remote configuration request.

In some embodiments of the present disclosure, the remote configuration mode supported by both the first network and/or the UE includes a UP remote configuration mode and/or a CP remote configuration mode.

In some embodiments of the present disclosure, the first core network device and the second core network device are AMFs or PCFs.

In some embodiments of the present disclosure, the first network is an O-SNPN, and the second network is a SO-SNPN.

In the apparatus for remotely configuring the UE in embodiments of the present disclosure, the UE sends the configuration request to the second core network device of the second network, and the configuration request includes the remote configuration mode supported by the first network and/or the UE; and the UE receives the remote configuration information. In this way, when the first network and the second network do not determine the available remote configuration mode in advance, the UE can determine the remote configuration information through negotiation, solving the technical problem of failing to determine the remote configuration mode actually adopted in the remote configuration process for the UE when the first network and the second network support a plurality of remote configuration modes in the prior art, and improving the flexibility and usability of the remote configuration for the UE.

In some embodiments of the present disclosure, the foregoing implementations may be executed individually or in combination, which is not limited in embodiments of the present disclosure.

Corresponding to the method for determining the remote configuration mode provided by embodiments of FIG. 16 as described above, the present disclosure further provides another apparatus for determining a remote configuration mode. Since the apparatus for determining the remote configuration mode provided by embodiments of the present disclosure corresponds to the method for determining the remote configuration mode provided by embodiments of FIG. 16 as described above, implementations of the method for determining the remote configuration mode are also applicable to the apparatus for determining the remote configuration mode provided by embodiments of the present disclosure, which are not described in details in embodiments of the present disclosure.

FIG. 22 is a schematic structural diagram of another apparatus for determining a remote configuration mode provided by an embodiment of the present disclosure. The apparatus may be applied in a first core network device.

As shown in FIG. 22, the apparatus 2200 for determining the remote configuration mode may include: a receiving module 2201, a first sending module 2202 and a second sending module 2203.

The receiving module 2201 is configured to receive a registration request sent by a User Equipment (UE).

The first sending module 2202 is configured to send a remote configuration mode supported by a first network to the UE.

The second sending module 2203 is configured to send remote configuration information to the UE.

In some embodiments of the present disclosure, the remote configuration information may include a configuration parameter, and the second sending module 2203 may further be configured to send a User Parameter Update (UPU) message to a second core network device of a second network, and the UPU message includes the configuration parameter.

In some embodiments of the present disclosure, the remote configuration information may further include subscription data, and the second sending module 2203 may further be configured to send the subscription data to the UE through a first user plane connection.

In some embodiments of the present disclosure, the first core network device and the second core network device are AMFs or PCFs.

In some embodiments of the present disclosure, the first network is an O-SNPN, and the second network is a SO-SNPN.

In the apparatus for remotely configuring the UE in embodiments of the present disclosure, the first core network device of the first network receives the registration request sent by the UE; the first core network device sends the remote configuration mode supported by the first network to the UE; and the first core network device sends the remote configuration information to the UE. In this way, the first core network device sends the remote configuration information to the UE side, so that the UE performs the remote configuration, which realizes that when there is a plurality of remote configuration modes, the UE can perform the remote configuration by using an applicable remote configuration mode.

In some embodiments of the present disclosure, the foregoing implementations may be executed individually or in combination, which is not limited in embodiments of the present disclosure.

Corresponding to the method for determining the remote configuration mode provided by embodiments of FIG. 17 as described above, the present disclosure further provides another apparatus for determining a remote configuration mode. Since the apparatus for determining the remote configuration mode provided by embodiments of the present disclosure corresponds to the method for determining the remote configuration mode provided by embodiments of FIG. 17 as described above, implementations of the method for determining the remote configuration mode are also applicable to the apparatus for determining the remote configuration mode provided by embodiments of the present disclosure, which are not described in details in embodiments of the present disclosure.

FIG. 23 is a schematic structural diagram of another apparatus for determining a remote configuration mode provided by an embodiment of the present disclosure. The apparatus may be applied in a second core network device.

As shown in FIG. 23, the apparatus 2300 for determining the remote configuration mode may include: a receiving module 2301 and a sending module 2302.

The receiving module 2301 is configured to receive a configuration request sent by a User Equipment (UE), and the configuration request includes a remote configuration mode supported by a first network and/or the UE.

The sending module 2302 is configured to send remote configuration information to the UE.

In some embodiments of the present disclosure, the remote configuration information may include a configuration parameter, and the sending module 2302 may further be configured to: receive a remote configuration request message sent by a first core network device of the first network; and send the remote configuration information to the UE, the configuration parameter is carried in the remote configuration information.

In some embodiments of the present disclosure, the remote configuration information may further include subscription data, and the sending module 2302 may further be configured to: send a remote configuration capability indication to the UE; receive a remote configuration request sent, according to the remote configuration capability indication, by the UE; and send the subscription data to the UE through a second user plane connection corresponding to the remote configuration request.

In some embodiments of the present disclosure, the first network is an O-SNPN, and the second network is a SO-SNPN.

In the apparatus for determining the remote configuration mode in embodiments of the present disclosure, the second core network device of the second network receives the configuration request sent by the UE, and the configuration request includes the remote configuration mode supported by the first network and/or the UE; and the second core network device sends the remote configuration information to the UE. In this way, the second core network device sends the remote configuration information to the UE side, so that the UE performs the remote configuration, so that the UE performs the remote configuration, which realizes that when there is a plurality of remote configuration modes, the UE can perform the remote configuration by using an applicable remote configuration mode.

In some embodiments of the present disclosure, the foregoing implementations may be executed individually or in combination, which is not limited in embodiments of the present disclosure.

In order to implement the above embodiments, the present disclosure further provides a communication device.

The communication device provided by embodiments of the present disclosure includes a processor, a transceiver, a memory, and an executable program stored in the memory and capable of being run by the processor. The processor performs the foregoing method when running the executable program.

The processor may include various types of storage mediums, and the storage medium is a non-transitory computer storage medium that can continue to memorize information stored on it after the communication device is powered off.

The processor may be connected to the memory through a bus or the like, and may be configured to read the executable program stored in the memory, to implement the above method, for example, at least one of the methods shown in FIGS. 1 to 17.

In order to realize the above embodiments, the present disclosure further provides a computer storage medium.

The computer storage medium provided by embodiments of the present disclosure stores an executable program which, when executed by a processor, can implement the above method, for example, at least one of the methods shown in FIGS. 1 to 17.

FIG. 24 is a block diagram of a user equipment 2400 provided by an embodiment of the present disclosure. For example, the user equipment 2400 may be a mobile phone, a computer, a digital broadcast user device, a messaging device, a gaming console, a tablet, a medical device, an exercise device, a personal digital assistant, etc.

Referring to FIG. 24, the user equipment 2400 may include at least one of the following components: a processing component 2402, a memory 2404, a power component 2406, a multimedia component 2408, an audio component 2410, an input/output (I/O) interface 2412, a sensor component 2414, and a communication component 2416.

The processing component 2402 typically controls overall operations of the user equipment 2400, such as operations associated with display, telephone calls, data communications, camera operations, and recording operations. The processing component 2402 may include at least one processor 2420 to execute instructions to perform all or part of the steps in the above described methods. Moreover, the processing component 2402 may include at least one module which facilitates the interaction between the processing component 2402 and other components. For instance, the processing component 2402 may include a multimedia module to facilitate the interaction between the multimedia component 2408 and the processing component 2402.

The memory 2404 is configured to store various types of data to support the operation of the user equipment 2400. Examples of such data include instructions for any applications or methods operated on the user equipment 2400, contact data, phonebook data, messages, pictures, video, etc. The memory 2404 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2406 provides power to various components of the user equipment 2400. The power component 2406 may include a power management system, at least one power source, and any other components associated with the generation, management, and distribution of power in the user equipment 2400.

The multimedia component 2408 includes a screen providing an output interface between the user equipment 2400 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake-up time and a pressure associated with the touch or swipe action. In some embodiments, the multimedia component 2408 includes a front camera and/or a rear camera. The front camera and the rear camera may receive an external multimedia datum while the user equipment 2400 is in an operation mode, such as a photographing mode or a video mode. Each of the front camera and the rear camera may be a fixed optical lens system or have focus and optical zoom capability.

The audio component 2410 is configured to output and/or input audio signals. For example, the audio component 2410 includes a microphone (MIC) configured to receive an external audio signal when the user equipment 2400 is in an operation mode, such as a call mode, a recording mode, and a voice recognition mode. The received audio signal may be further stored in the memory 2404 or transmitted via the communication component 2416. In some embodiments, the audio component 2410 further includes a speaker to output audio signals.

The I/O interface 2412 provides an interface between the processing component 2402 and peripheral interface modules, such as a keyboard, a click wheel, buttons, and the like. The buttons may include, but are not limited to, a home button, a volume button, a starting button, and a locking button.

The sensor component 2414 includes at least one sensor to provide status assessments of various aspects of the user equipment 2400. For instance, the sensor component 2414 may detect an open/closed status of the user equipment 2400, relative positioning of components, e.g., the display and the keypad, of the user equipment 2400, a change in position of the user equipment 2400 or a component of the user equipment 2400, a presence or absence of user contact with the user equipment 2400, an orientation or an acceleration/deceleration of the user equipment 2400, and a change in temperature of the user equipment 2400. The sensor component 2414 may include a proximity sensor configured to detect the presence of nearby objects without any physical contact. The sensor component 2414 may also include a light sensor, such as a CMOS or CCD image sensor, for use in imaging applications. In some embodiments, the sensor component 2414 may also include an accelerometer sensor, a gyroscope sensor, a magnetic sensor, a pressure sensor, or a temperature sensor.

The communication component 2416 is configured to facilitate communication, wired or wirelessly, between the user equipment 2400 and other devices. The user equipment 2400 may access a wireless network based on a communication standard, such as WiFi, 2G, or 3G, or a combination thereof. In an embodiment, the communication component 2416 receives a broadcast signal or broadcast associated information from an external broadcast management system via a broadcast channel. In an embodiment, the communication component 2416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the user equipment 2400 may be implemented with at least one application specific integrated circuit (ASIC), digital signal processor (DSP), digital signal processing apparatus (DSPD), programmable logic apparatus (PLD), field programmable gate array (FPGA), controller, micro-controller, microprocessor, or other electronic components, for performing the method for remotely configuring the UE in any embodiment of FIGS. 1 to 4 as described above, or the method for remotely configuring the UE in any embodiment of FIGS. 12 to 15 as described above.

In an embodiment, there is further provided a non-transitory computer readable storage medium including instructions, such as the memory 2404 including instructions, the above instructions may be executed by the processor 2420 in the user equipment 2400 for performing the above-described methods. For example, the non-transitory computer-readable storage medium may be a ROM, a Random Access Memory (RAM), a CD-ROM, a magnetic tape, a floppy disc, an optical data storage device, and the like.

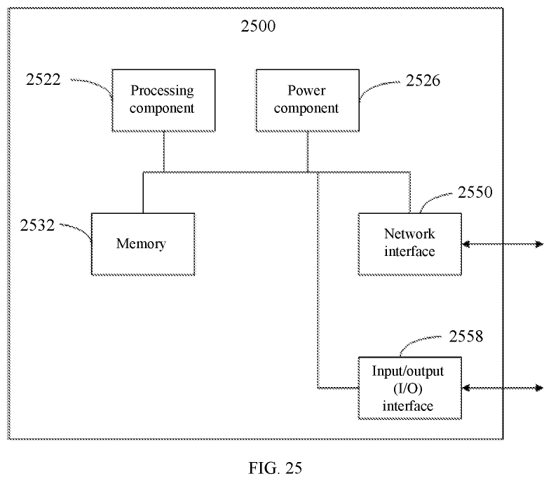

As shown in FIG. 25, it is a schematic structural diagram of a network device provided by an embodiment of the present disclosure. The network device may be the first core network device or the second core network device in the foregoing embodiments. Referring to FIG. 25, the network device 2500 includes a processing component 2522, which further includes at least one processor and a memory resource represented by a memory 2532 for storing instructions executable by the processing component 2522, such as an application program. The application program stored in the memory 2532 may include one or more modules, each corresponding to a set of instructions. In addition, the processing component 2522 is configured to execute the instructions to execute any of the aforementioned methods applied in the access network device or the core network device, for example, the method for determining the remote configuration mode as shown in FIGS. 5 to 10, or the method for determining the remote configuration mode in FIG. 11, or the method for determining the remote configuration mode in FIG. 16, or the method for determining the remote configuration mode in FIG. 17.

The network device 2500 may also include: a power component 2526 configured to perform power management of the network device 2500, a wired or wireless network interface 2550 configured to connect the network device 2500 to the network, and an input/output (I/O) interface 2558. The network device 2500 may operate an operating system stored in the memory 2532, such as Windows Server™, Mac OS X™, Unix™, Linux™, FreeBSD™, or the like.

In a first aspect, embodiments of the present disclosure provide a method for remotely configuring a User Equipment (UE), including: sending, by the UE, a registration request to a first core network device of a first network; receiving, by the UE, an available remote configuration mode sent by the first core network device, wherein the available remote configuration mode is determined by a remote configuration mode supported by the first network and/or a remote configuration mode supported by a second network; and performing, by the UE, remote configuration according to the available remote configuration mode.

In some embodiments of the present disclosure, the receiving, by the UE, the available remote configuration mode sent by the first core network device includes: receiving, by the UE, a registration response message sent by the first core network device, wherein if the registration response message is a registration success message, the available remote configuration mode is carried in the registration response message.

In some embodiments of the present disclosure, the receiving, by the UE, the available remote configuration mode sent by the first core network device includes: receiving, by the UE, a policy message sent through a Policy Control Function (PCF) by the first core network device, wherein the available remote configuration mode is carried in the policy message.

In some embodiments of the present disclosure, the performing, by the UE, the remote configuration according to the available remote configuration mode includes: obtaining, by the UE, a remote configuration mode supported by the UE; selecting, by the UE, a target remote configuration mode according to the remote configuration mode supported by the UE and the available remote configuration mode; and performing, by the UE, the remote configuration according to the target remote configuration mode.

In some embodiments of the present disclosure, the available remote configuration mode includes a User Plane (UP) remote configuration mode and/or a Control Plane (CP) remote configuration mode.

In some embodiments of the present disclosure, the first core network device is an Access and Mobility Management Function (AMF) or a PCF.

In some embodiments of the present disclosure, the first network is an Onboarding Standalone Non-Public Network (O-SNPN), and the second network is a Subscription Owner Standalone Non-Public Network (SO-SNPN).

In a second aspect, embodiments of the present disclosure provide a method for determining a remote configuration mode, including: receiving, by a first core network device of a first network, a registration request of a User Equipment (UE); determining, by the first core network device, an available remote configuration mode according to a remote configuration mode supported by the first network and/or a remote configuration mode supported by a second network; and sending, by the first core network device, the available remote configuration mode to the UE.

In some embodiments of the present disclosure, before the determining, by the first core network device, the available remote configuration mode according to the remote configuration mode supported by the first network and the remote configuration mode supported by the second network, the method further includes: preconfiguring, by the first core network device, the remote configuration mode supported by the second network to the first core network device.

In some embodiments of the present disclosure, before the determining, by the first core network device, the available remote configuration mode according to the remote configuration mode supported by the first network and the remote configuration mode supported by the second network, the method further includes: sending, by the first core network device, a UE registration success message to a second core network device of the second network; and receiving, by the first core network device, the remote configuration mode supported by the second network that is sent by the second core network device.

In some embodiments of the present disclosure, the determining, by the first core network device, the available remote configuration mode according to the remote configuration mode supported by the first network and the remote configuration mode supported by the second network includes: selecting, by the first core network device, a remote configuration mode commonly supported by the first network and the second network according to the remote configuration mode supported by the first network and the remote configuration mode supported by the second network; and determining, by the first core network device, the available remote configuration mode according to the commonly supported remote configuration mode.

In some embodiments of the present disclosure, the determining, by the first core network device, the available remote configuration mode according to the commonly supported remote configuration mode includes: obtaining, by the first core network device, a pre-configuration policy message and/or network parameter information; and selecting, by the first core network device, the available remote configuration mode from the commonly supported remote configuration mode according to the pre-configuration policy message and/or the network parameter information.

In some embodiments of the present disclosure, the network parameter information includes one or more of network load information and network capability information of the first network and/or the second network.

In some embodiments of the present disclosure, the sending, by the first core network device, the available remote configuration mode to the UE includes: sending, by the first core network device, a registration success message to the UE, wherein the available remote configuration mode is carried in the registration success message.

In some embodiments of the present disclosure, the sending, by the first core network device, the available remote configuration mode to the UE includes: sending, by the first core network device, a policy message to the UE through a PCF, wherein the available remote configuration mode is carried in the policy message.

In some embodiments of the present disclosure, a remote configuration mode supported by the first network and the second network includes a UP remote configuration mode and/or a CP remote configuration mode.

In some embodiments of the present disclosure, the first network is an O-SNPN, and the second network is a SO-SNPN.

In some embodiments of the present disclosure, the first core network device is an AMF or a PCF.

In a third aspect, embodiments of the present disclosure provide another method for determining a remote configuration mode, including: receiving, by a second core network device of a second network, a UE registration success message sent by a first core network device of a first network; and sending, by the second core network device, a remote configuration mode supported by the second network to the first core network device, so that an available remote configuration mode is generated by the first core network device according to a remote configuration mode supported by the first network and/or the remote configuration mode supported by the second network.

In some embodiments of the present disclosure, the first network is an O-SNPN, and the second network is a SO-SNPN.

In a fourth aspect, embodiments of the present disclosure provide a method for remotely configuring a User Equipment (UE), including: sending, by the UE, a configuration request to a second core network device of a second network, wherein the configuration request includes a remote configuration mode supported by a first network and/or the UE; and receiving, by the UE, remote configuration information.

In some embodiments of the present disclosure, before the sending, by the UE, the configuration request to the second core network device of the second network, the method further includes: sending, by the UE, a registration request to a first core network device of the first network; and receiving, by the UE, the remote configuration mode supported by the first network that is sent by the first core network device.

In some embodiments of the present disclosure, the remote configuration information includes a configuration parameter, wherein the receiving the remote configuration information includes: receiving, by the UE, a Non-Access Stratum (NAS) message sent by the second core network device, wherein the configuration parameter is carried in the NAS message.

In some embodiments of the present disclosure, the remote configuration information includes subscription data, and the receiving, by the UE, the remote configuration information includes: receiving, by the UE, the subscription data sent through a first user plane connection by a first core network device.

In some embodiments of the present disclosure, the remote configuration information includes subscription data, and the receiving, by the UE, the remote configuration information includes: receiving, by the UE, a remote configuration capability indication sent by the second core network device; initiating, by the UE, the remote configuration request to the second core network device according to the remote configuration capability indication; and receiving, by the UE, the subscription data through a second user plane connection corresponding to the remote configuration request.

In some embodiments of the present disclosure, the remote configuration mode supported by both the first network and/or the UE includes a UP remote configuration mode and/or a CP remote configuration mode.

In some embodiments of the present disclosure, the first core network device and the second core network device are AMFs or PCFs.

In some embodiments of the present disclosure, the first network is an O-SNPN, and the second network is a SO-SNPN.

In a fifth aspect, embodiments of the present disclosure provide another method for determining a remote configuration mode, including: receiving, by a second core network device of a second network, a configuration request sent by a User Equipment (UE), wherein the configuration request includes a remote configuration mode supported by a first network and/or the UE; and sending, by the second core network device, remote configuration information to the UE.

In some embodiments of the present disclosure, the remote configuration information includes a configuration parameter, and the sending, by the second core network device, the remote configuration information to the UE includes: receiving, by the second core network device, a remote configuration request message sent by a first core network device of the first network; and sending, by the second core network device, the remote configuration information to the UE, wherein the configuration parameter is carried in the remote configuration information.

In some embodiments of the present disclosure, the remote configuration information includes subscription data, and the sending, by the second core network device, the remote configuration information to the UE includes:
sending, by the second core network device, a remote configuration capability indication to the UE;
receiving, by the second core network device, a remote configuration request sent, according to the remote configuration capability indication, by the UE; and
sending, by the second core network device, subscription data to the UE through a second user plane connection corresponding to the remote configuration request.

In some embodiments of the present disclosure, the first network is an O-SNPN, and the second network is a SO-SNPN.

In a sixth aspect, embodiments of the present disclosure provide an apparatus for remotely configuring a User Equipment (UE), including: a sending module, configured to send a registration request to a first core network device of a first network; a receiving module, configured to receive an available remote configuration mode sent by the first core network device, wherein the available remote configuration mode is determined by a remote configuration mode supported by the first network and/or a remote configuration mode supported by the second network; and a configuration module, configured to perform remote configuration according to the available remote configuration mode.

In a seventh aspect, embodiments of the present disclosure provide an apparatus for determining a remote configuration mode, including: a receiving module, configured to receive a registration request of a UE; a determining module, configured to determine an available remote configuration mode according to a remote configuration mode supported by the first network and/or a remote configuration mode supported by a second network; and a sending module, configured to send the available remote configuration mode to the UE.

In an eighth aspect, embodiments of the present disclosure provide another apparatus for determining a remote configuration mode, including: a receiving module, configured to receive a UE registration success message sent by a first core network device of a first network; and a sending module, configured to send a remote configuration mode supported by the second network to the first core network device, so that an available remote configuration mode is generated by the first core network device according to a remote configuration mode supported by the first network and the remote configuration mode supported by the second network.

In a ninth aspect, embodiments of the present disclosure provide an apparatus for remotely configuring a User Equipment (UE), including: a first sending module, configured to send a configuration request to a second core network device of a second network, wherein the configuration request includes a remote configuration mode supported by a first network and/or the UE; and a receiving module, configured to receive remote configuration information.

In a tenth aspect, embodiments of the present disclosure provide another apparatus for determining a remote configuration mode, including: a receiving module, configured to receive a configuration request sent by a User Equipment (UE), wherein the configuration request includes a remote configuration mode supported by a first network and/or the UE; and a sending module, configured to send remote configuration information to the UE.

In an eleventh aspect, embodiments of the present disclosure provide a communication device, including: a transceiver; a memory; and a processor, respectively connected to the transceiver and the memory, and configured to, by executing computer-executable instructions in the memory, control a wireless signal transmission and reception of the transceiver, and implement the method for remotely configuring the UE provided in the first aspect of the present disclosure, or implement the method for determining the remote configuration mode provided in the second aspect of the present disclosure, or implement the method for determining the remote configuration mode provided in the third aspect of the present disclosure, or implement the method for remotely configuring the UE provided in the fourth aspect of the present disclosure, or implement the method for determining the remote configuration mode provided in the fifth aspect of the present disclosure.

In a twelfth aspect, embodiments of the present disclosure provide a computer storage medium having computer-executable instructions stored thereon, which, when executed by a processor, are capable of implementing the method for remotely configuring the UE provided in the first aspect of the present disclosure, or implementing the method for determining the remote configuration mode provided in the second aspect of the present disclosure, or implementing the method for determining the remote configuration mode provided in the third aspect of the present disclosure, or implementing the method for remotely configuring the UE provided in the fourth aspect of the present disclosure, or implementing the method for determining the remote configuration mode provided in the fifth aspect of the present disclosure.

In a thirteenth aspect, embodiments of the present disclosure provide a computer program product, including a computer program, which, when executed by a processor, implements the method for remotely configuring the UE provided in the first aspect of the present disclosure, or implements the method for determining the remote configuration mode provided in the second aspect of the present disclosure, or implements the method for determining the remote configuration mode provided in the third aspect of the present disclosure, or implements the method for remotely configuring the UE provided in the fourth aspect of the present disclosure, or implements the method for determining the remote configuration mode provided in the fifth aspect of the present disclosure.

In the method for remotely configuring the UE provided by embodiments of the present disclosure, the UE sends the registration request to the first core network device of the first network; the UE receives the available remote configuration mode sent by the first core network device, and the available remote configuration mode is determined by the remote configuration mode supported by the first network and/or the remote configuration mode supported by the second network; and the UE performs the remote configuration according to the available remote configuration mode. Since the available remote configuration mode is determined according to the remote configuration modes supported by the first network and/or the second network, it is realized that the UE performs the remote configuration by selecting the remote configuration mode supported by itself from the available remote configuration mode, avoiding the technical problem of failing to determine the remote configuration mode adopted in the remote configuration process for the UE in the prior art, and improving the flexibility and usability of the remote configuration for the UE.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for remotely configuring a User Equipment (UE), comprising:
sending, by the UE, a registration request to a first core network device of a first network;
receiving, by the UE, an available remote configuration mode sent by the first core network device, wherein the available remote configuration mode is determined by a remote configuration mode supported by the first network and/or a remote configuration mode supported by a second network; and
performing, by the UE, remote configuration according to the available remote configuration mode.

2. The method according to claim 1, wherein the receiving, by the UE, the available remote configuration mode sent by the first core network device comprises:
receiving, by the UE, a registration response message sent by the first core network device, wherein in response to a successful registration, the available remote configuration mode is carried in the registration response message by the first core network device.

3. The method according to claim 1, wherein the receiving, by the UE, the available remote configuration mode sent by the first core network device comprises:
receiving, by the UE, a policy message sent through a Policy Control Function (PCF) by the first core network device, wherein the available remote configuration mode is carried in the policy message.

4. The method according to claim 1, wherein the performing, by the UE, the remote configuration according to the available remote configuration mode comprises:
obtaining, by the UE, a remote configuration mode supported by the UE;
selecting, by the UE, a target remote configuration mode according to the remote configuration mode supported by the UE and the available remote configuration mode; and
performing, by the UE, the remote configuration according to the target remote configuration mode.

5. The method according to claim 1, wherein the available remote configuration mode comprises a User Plane (UP) remote configuration mode and/or a Control Plane (CP) remote configuration mode.

6-7. (canceled)

8. A method for determining a remote configuration mode, comprising:
receiving, by a first core network device of a first network, a registration request of a User Equipment (UE);
determining, by the first core network device, an available remote configuration mode according to a remote configuration mode supported by the first network and/or a remote configuration mode supported by a second network; and
sending, by the first core network device, the available remote configuration mode to the UE.

9. The method according to claim 8, wherein before the determining, by the first core network device, the available remote configuration mode according to the remote configuration mode supported by the first network and the remote configuration mode supported by the second network, the method further comprises:
preconfiguring, by the first core network device, the remote configuration mode supported by the second network to the first core network device.

10. The method according to claim 8, wherein before the determining, by the first core network device, the available remote configuration mode according to the remote configuration mode supported by the first network and the remote configuration mode supported by the second network, the method further comprises:
sending, by the first core network device, a UE registration success message to a second core network device of the second network; and
receiving, by the first core network device, the remote configuration mode supported by the second network that is sent by the second core network device.

11. The method according to claim 8, wherein the determining, by the first core network device, the available remote configuration mode according to the remote configuration mode supported by the first network and/or the remote configuration mode supported by the second network comprises:
selecting, by the first core network device, a remote configuration mode commonly supported by the first network and the second network according to the remote configuration mode supported by the first network and the remote configuration mode supported by the second network; and
determining, by the first core network device, the available remote configuration mode according to the remote configuration mode commonly supported by the first network and the second network.

12. The method according to claim 11, wherein the determining, by the first core network device, the available remote configuration mode according to the remote configuration mode commonly supported by the first network and the second network comprises:
obtaining, by the first core network device, a pre-configuration policy message and/or network parameter information; and
selecting, by the first core network device, the available remote configuration mode from the remote configuration mode commonly supported by the first network and the second network according to the pre-configuration policy message and/or the network parameter information.

13. The method according to claim 12, wherein the network parameter information comprises one or more of network load information of the first network and/or the second network, and network capability information of the first network and/or the second network.

14. The method according to claim 8, wherein the sending, by the first core network device, the available remote configuration mode to the UE comprises:
sending, by the first core network device, a registration success message to the UE, wherein the available remote configuration mode is carried in the registration success message.

15. The method according to claim 8, wherein the sending, by the first core network device, the available remote configuration mode to the UE comprises:
sending, by the first core network device, a policy message to the UE through a Policy Control Function (PCF), wherein the available remote configuration mode is carried in the policy message.

16-18. (canceled)

19. A method for determining a remote configuration mode, comprising:
receiving, by a second core network device of a second network, a User Equipment (UE) registration success message sent by a first core network device of a first network; and
sending, by the second core network device, a remote configuration mode supported by the second network to the first core network device.

20-33. (canceled)

34. A User Equipment (UE), comprising:
a transceiver;
a memory; and
a processor, respectively connected to the transceiver and the memory, and configured to, by executing computer-executable instructions in the memory, implement the method for remotely configuring the UE according to claim 1.

35. A first core network device, comprising:
a transceiver;
a memory; and
a processor, respectively connected to the transceiver and the memory, and configured to, by executing computer-executable instructions in the memory, implement the method for determining the remote configuration mode according to claim 8.

36. A second core network device, comprising:
a transceiver;
a memory; and
a processor, respectively connected to the transceiver and the memory, and configured to, by executing computer-executable instructions in the memory, implement the method for determining the remote configuration mode according to claim 19.

37-39. (canceled)

40. The UE according to claim 34, wherein the processor is further configured to:
receive a registration response message sent by the first core network device, wherein in response to a successful registration, the available remote configuration mode is carried in the registration response message by the first core network device.

41. The UE according to claim 34, wherein the processor is further configured to:
receive, a policy message sent through a Policy Control Function (PCF) by the first core network device, wherein the available remote configuration mode is carried in the policy message.

42. The UE according to claim 34, wherein the processor is further configured to:
obtain a remote configuration mode supported by the UE;
select a target remote configuration mode according to the remote configuration mode supported by the UE and the available remote configuration mode; and
perform the remote configuration according to the target remote configuration mode.
